(19) United States
(12) Patent Application Publication
(10) Pub. No.: US 2026/0093410 A1
(43) Pub. Date: Apr. 2, 2026

(54) METHOD AND SYSTEM FOR EXTRACTING PRIVILEGED INFORMATION FROM A MOBILE DEVICE AND DETERMINING PROOF OF SECURE ERASURE

(71) Applicant: A LA CARTE MEDIA, INC., Montreal (CA)

(72) Inventors: Dominique DION, Montreal (CA); Tony MASTRONARDI, Montreal (CA)

(21) Appl. No.: 19/254,294

(22) Filed: Jun. 30, 2025

Related U.S. Application Data
(63) Continuation of application No. PCT/IB2024/050033, filed on Jan. 2, 2024.
(60) Provisional application No. 63/436,509, filed on Dec. 31, 2022.

(30) Foreign Application Priority Data
Jan. 2, 2024 (WO) PCT/IB2024/050033

(51) Int. Cl. G06F 3/06

(52) U.S. Cl. CPC G06F 3/0652; G06F 3/0604; G06F 3/0673

(57) ABSTRACT

The technology presented herein relates to change of ownership and/or protection (e.g., for insurance, warranty, etc.) of pre-owned portable electronic devices (POD) for trade-in, recycling, evaluation, or the like. More particularly, this technology relates to the accessing of privileged information on the POD and/or secure erasure of information on the POD. Methods and systems are described for accessing of privileged information on the POD. Some methods and systems are provided to, in addition, provide improved proof of secure erasure of the POD.

### CROSS-REFERENCE TO RELATED APPLICATIONS

This application claims priority to PCT Application No. PCT/IB2024/050033 filed on Jan. 2, 2024, which claimed priority to U.S. Provisional Patent Application No. 63/436,509 filed Dec. 31, 2022, the entire contents of both applications of which are incorporated herein by reference.

### FIELD OF THE TECHNOLOGY

The technology presented herein relates to change of ownership and/or protection of pre-owned portable electronic devices (POD) for trade-in, recycling, evaluation or the like. More particularly, this technology relates to accessing of privileged information on the POD and/or secure erasure of information on the POD.

### BACKGROUND

Over the years, several solutions have been developed to improve pre-owned smartphone and other pre-owned portable electronic devices (POD) diagnostics, cosmetic assessments in order to provide or facilitate service such as portable electronic device (e.g., smartphone) trade-in, consumer to consumer trade-in, device diagnostics for repair assessments or quotes, validating device condition for determining insurance or protection plan eligibility, etc. Such solutions have been developed generally in the form of device tethering systems, applications and kiosks. Over the years, companies providing these solutions have formed around this ecosystem that has evolved as service providers to retailers, consumers, and others, by providing services and trade channels for used (e.g., second hand) smartphones. Other solutions, limited in their abilities, have been developed as pure mobile applications, for example Phone Doctor™, a well-known phone diagnostic application.

The most deployed portable device operating systems are developed by Apple™ (iOS™, TV-OS™) and Google™ (Android™) and as such they are important stakeholders in this ecosystem. They sometimes provide new technologies, facilities and features, and sometimes new obstacles, for example, as will be described herein how the access to the International Mobile Equipment Identity (IMEI) identifier is restricted from being accessed programmatically. Additionally, certain other device or user information are not programmatically accessible, most often to protect the privacy of users but are legitimately required when a device is about to change ownership or is being evaluated for purposes of obtaining/providing protection (e.g., insurance, warranty, etc.) for the device. Such information is referred to herein as “privileged information.”

Among important recent introductions are: advances in cameras and image processing, including multiple cameras; biometric features (e.g., fingerprint and face recognition); OLED and AMOLED displays; improved user privacy protection including phasing out or restricting access to cookies, MAC, IMEI, Bluetooth ID, etc.; facilitating device transfer process (e.g., erasure of personal data and simplified data transfer functions); battery lifecycle information available in the “Settings page”; and flip phones.

An important pressure point has emerged from large electronic/smartphone retailers, namely when it comes to “trading-in” an older smartphone against value toward a new phone in that the process has to be as simple as possible for the consumer and staff. This reduces many of the possibilities for doing a complete device assessment at the time of purchase (e.g., upgrade) as the steps required for the user (e.g., customer selling the device or retailer staff) adds complexity, for example, as the user is required to press different areas on the screen, take pictures, etc. Because of this, retailers have pushed the service providers to accept very simple evaluations of the PODs and as such, a POD is very often valued based on a handful of key questions. The most commons are: is the phone in working condition?; is the glass/screen free of defects?; is the device free from any lien (finance locked to a third party) as well as unlocked from the operating system (i.e. iCloud lock/aka Find my iPhone for Apple devices or user and activation lock for Android based devices.

Other service providers within the ecosystem, for instance protection plan/insurance providers, may have different requirements with regards to the variety of test points and thoroughness of the evaluations or physical inspections they require. These applications may also benefit from the present disclosure for example in using the means to adequately and reliably acquiring device and user information, as furthermore described herein.

These recently introduced features and simplified user experience constraints have introduced new challenges and opportunities to the used smartphone ecosystem.

The industry has also suffered from various problems that remained challenging. For instance, the ability to accurately identify a specific phone model and options such as storage capacity.

The industry, like others, is also demanding automation, that is, having the end-users complete most of not all the transactions by themselves, with simple and convenient approaches.

The present disclosure provides some solutions to these problems and challenges.

### SUMMARY

According to an embodiment, a system for determining a proof of secure erasure (PoSE) of a pre-owned portable electronic device (POD) is provided. The system comprises the POD comprising at least one first processor and a local storage, and a companion device comprising at least one second processor, a display device and a camera. The companion device is configured to communicate with at least one server comprising at least one third processor.

One or more processors of the system are configured to perform operations comprising: causing the POD to display at least one privileged information on a display device of the POD; capturing by the camera of the companion device or by accessing a framebuffer of the POD an image of the displayed at least one privileged information; extracting an identifier of the POD from the image as a first evidence; querying at least one server using the extracted identifier; providing user instructions on how to securely perform an erasure of data of the local storage; receiving from the at least one server information associated with a status of the POD, as a second evidence; determining the PoSE of the POD, based at least on the first evidence and the second evidence; and storing at least one of the first evidence, the second evidence or a status of the determined POSE.

An embodiment provides a method for determining a PoSE of a POD. The method comprising: causing the POD to display at least one privileged information on a display device of the POD; capturing by the camera of a companion device or by accessing a framebuffer of the POD an image of the displayed at least one privileged information; extracting an identifier of the POD from the image as a first evidence; querying at least one server using the extracted identifier; providing user instructions on how to securely perform an erasure of data of the local storage; receiving from the at least one server information associated with a status of the POD, as a second evidence; determining the PoSE of the POD, based at least on the first evidence and the second evidence; and storing at least the first evidence and the second evidence.

An embodiment provides a method executed on a POD. The method comprising: requesting, from an operating system of the POD, read access to a framebuffer memory of the POD; requesting, from the operating system, for write access to at least a part of the framebuffer memory; rendering, using the write access to the at least part of the framebuffer memory, navigation instructions for guiding a user on steps to be performed for causing display of the privileged information; detecting, using the read access to the framebuffer memory, privileged information displayed as a consequence of the user performing at least some of the navigation instructions; and responsive to the detecting, sending to a companion device at least one of a notification that the privileged information has been detected, a plain copy of the privileged information, or an encrypted or hashed copy of the privileged information. An embodiment provides a system comprising one or more processors and one or more memory devices. The one or more processors are configured to: detect at least one of a manufacturer of the POD or an operating system of the POD and, responsive to the detecting, select or adapt an instruction set from at least two instruction sets; provide, from the instruction set, multimedia, audio, text and/or video instructions indicating steps to be performed by a user for navigating to one or more screens that contain a relevant information, wherein the relevant information includes at least one of an International Mobile Equipment Identity (IMEI), MAC address, serial number, model number, battery health information, or storage capacity; capture at least one image, either by using a camera or by using a direct or indirect access to a framebuffer memory of the POD, the image containing the relevant information displayed on the POD as a consequence of execution of the instruction set by the user; extracting, using the at least one image, the relevant information; and storing the extracted relevant information in a data container in the one or more memory devices.

### BRIEF DESCRIPTION OF THE DRAWINGS

FIG. 1 illustrates an example pre-owned portable electronic devices (POD) displaying in its system setting screen certain information such as a model number and its commercial name, etc. that may be hard to access and/or not programmatically accessible.

FIG. 2 (FIG. 2A and FIG. 2B) illustrates an example sequence of navigation instructions displayed on a companion device (for example, a kiosk, a portable inspection device (PED), POS or a website) when a POD is being operated in accordance with the example sequence of navigation instructions, according to some embodiments.

FIG. 3 illustrates a POD on which a picture in picture (PiP) window overlays on part of the display o while providing the navigation instructions, according to some embodiments.

FIG. 4 illustrates an exemplary navigation into the system setting screen with PiP instructions provided by the mobile executable software, according to some embodiments.

FIG. 5 illustrates an example screen that provides a framework for applications to access/record the screen after the adequate permissions have been granted by the user, according to some embodiments.

FIG. 6 illustrates an example POD screen that displays additional system information (e.g., battery information).

FIG. 7 illustrates an example POD screen displaying a PiP window.

FIG. 8 illustrates a flowchart of a process using navigation-based information capturing with PiP in accordance with some embodiments.

FIG. 9 illustrates an example POD with instructions for performing data backup and data erasure using the recommended manufacturer method according to some embodiments.

FIG. 10 illustrates an example of evidence of a factory reset that can be obtained by camera-based information recognition of the POD which needs to be powered on and following a user touching the screen or a button which causes the initial operating system to display a known screen such as a “Hello” screen.

FIG. 11 illustrates an example of evidence of a factory reset that can be obtained by camera-based information recognition of the POD which needs to be powered on and following a user touching the screen or a button which causes the initial operating system to display an information screen.

FIG. 12 an example installation process of fully managed MDM applications on Android devices that begins by instructing the user to tap multiple times on the mobile device screen, and causes the display of a special enrollment page which turns the camera into QR scanning mode.

FIG. 13 an example POD that provides instructions to the user for installing the SP MDM, for example using a companion device and displaying a specially encoded QR code containing MDM enrollment information.

FIG. 14 illustrates an exemplary process using camera-based information recognition of a POD, according to some embodiments.

FIG. 15 illustrates an exemplary process for PoSE of a POD using a companion device pairing the user, POD and companion device using mobile telephone number and PIN, according to some embodiments.

FIG. 16 illustrates an exemplary process for PoSE of a POD using a companion device, according to some embodiments.

FIG. 17 illustrates an exemplary process for validating evidence for POSE of a POD, according to some embodiments.

FIG. 18 illustrates a flowchart for a process for providing POSE for a POD, according to some embodiments.

FIG. 19 illustrates a flowchart for a process for providing privileged information optionally in association with PoSE, according to some embodiments.

### DETAILED DESCRIPTION OF EXAMPLE EMBODIMENTS

Exemplary embodiments of this disclosure include methods and systems for accessing privileged information and/or providing improved proof of secure erasure of pre-owned portable electronic devices (POD), such as, but not limited to, smartphones, tablet computers, smart watches, game devices, personal health monitoring devices, or other processor-based electronic devices. The accessing of privileged and/or proof of secure erasure may be used, for example, during a trade-in or other evaluation of a POD. These embodiments will be described with reference to the accompanying drawings. It should be noted that the embodiments described below are illustrative only, and is not intended to limit embodiments according to this disclosure to specific configurations described below. Other specific configurations may be employed as appropriate according to the embodiments.

One current problem in the ecosystem is that trading, transferring, or surrendering POD (even for recycling) may be done, consciously or not, with personal and/or sensitive user information remaining on the device (“sensitive user information”). In many use cases, including trading up, giving, recycling or selling, sensitive user information such as all pictures, emails, contacts, calendar events and many other application data needs to first be removed both for protecting the original user privacy and protecting the intermediary parties (retailer, reverse logistic partner, etc.) from possible liability should any of such personal or sensitive information be made public by mistake or malicious persons, including their own staff.

Previously, some private solutions have emerged from solutions providers to provide retailers with data erasure systems/devices. Typically, these systems are tethered systems that connect physically to the POD and perform the necessary instructions to remove all or most of the personal data. These solutions are incomplete in that they may not comply with the OEM (Original Equipment Manufacturer)/OSP (Operating System Provider) recommended methods, they are also unsuitable for in-home applications or direct C2C trades, where trade-in or selling process is mostly completed at-home/online and the device is mailed or possibly exchanged in person (e.g., such as in direct C2C device trading). They also can complicate in store transactions when specific hardware is needed for proper usage.

IMEI (International Mobile Equipment Identity) are unique numbers associated to many POD types (any POD that can connect to a wireless network such as, e.g., 3G, LTE, 5G) and are important for several purposes related to the ecosystem. Its primary use relates to smartphone activation with a carrier, but the IMEI has been used for several alternate use-cases. For instance, the IMEI may be used: to uniquely identify a device in a customer account; to access finance or account databases in order to validate that the device is not being financed/has any lien; to identify some meta-information about the device, such as the manufacturer and model information; to verify that a device it is not currently associated to a user account (e.g., account lock such Apple iCloud/“Find my iphone” lock or Android's equivalent); to verify that a device was not reported lost or stolen (e.g., blacklisted); to verify if a device is a “managed device”, also referred to as “MDM” for Mobile Device Management; and/or to enroll a device as a managed device (e.g., owned or controlled by an organization IT department); and to provide device certification for data erasure, such as Proof of Secure Erasure (PoSE).

To validate or do any of the above, the IMEI is generally a key field for accessing these services/databases through some service interface (“service interface” as previously described by the applicant but, for example, using a REST API). Such services interfaces are offered typically in the form of a web page, or through an API, for example, as offered by Prolog Mobile™. Most services that require to uniquely identify a mobile device, new or POD, will typically rely on the IMEI. Some techniques are known for a mobile application to acquire the device IMEI namely by installing certificates, which was a cumbersome process and is being phased-out or restricted by both Apple and Google's operating systems. Some solutions have used barcode scanning, but requires that the IMEI be provided in barcode (or QC code), and that the system be able to scan barcodes, including barcodes through glass which is sometime problematic. Some solutions rely on OCR, other relies on “typing in” or “copy and paste” methods which are subject to errors but also open doors to falsified device transfer, for example when a user would not paste the real device IMEI, or present the valid device IMEI, which could cause problems in identifying blacklisted phones for example.

Because IMEI are sensitive as they can be used for device identification falsification, and also can be personally identifiable information, software applications are generally restricted from accessing this unique identifier. Nowadays, operating systems tend to allow IMEI access only using user navigation either by having the user navigate to a “System Setting” page, or either having the user dial “*#06#”, a USSD (Unstructured Supplementary Service Data) code that will cause most smartphone or phone-capable device to display a page containing their IMEI. Because of this, the POD ecosystem suffers from a safe, faultless method for capturing the IMEI in a programmatic manner.

### Data Erasure and PII

It is important for many parties in the ecosystem that under some use-cases, namely “ownership transfer” use-cases, such as C2B trade-in or C2C user device selling, that POD transfers be securely erased and freed from sensitive user information before the original owner disposes of the device, namely because the device could contain Personally Identifiable Information (PII), including sensitive information (e.g., account numbers, chat, emails, pictures, audio, video etc.), and could also contain malware.

The seller is generally the most interested party in making sure that upon disposal of the device. Other parties (e.g., the buyer, the retailer, the processor, etc.) should also desire that the device be free from any personal information because if the device is not securely erased, they will likely need to do it anyway, if not, they could be liable for loss or damages resulting in data leaks.

On the other hand, the buyer should be concerned that the POD is properly reset according to manufacturer's recommendations in order to ensure that no malware, virus or other inappropriate content or application resides on the POD being purchased.

Currently, C2B trade-in generally uses third party device test-and-erase systems, such as test systems provided by Blancco™ or PhoneCheck™, for example.

Nowadays, both Google (Android) and Apple (iOS) have clear recommendations on how to properly perform data-erasure before device disposal or ownership transfer. They have also included methods or assistance for data backup, data transfer and data erasure for simplifying the data migration when a user purchases a new device and wishes to migrate content safely from the user's POD. However, none of them provide methods for a third party to determine proof of secure erasure (PoSE), including keeping an external record thereof.

At the core of the some example embodiments of the current invention is a software arrangement organized as a computing cluster where parts of the software, herein “software components,” may be executed on the POD, parts being executed on an inspection or companion device such as a PED or a kiosk, and parts of the software being executed on at least one server which may be virtualized and distributed while other parts can be executed on any of these or other computing devices.

Software components are generally organized in a logical manner as at least one but generally a group of functions, modules, components or series of computable instructions and/or data, including artificial intelligence (AI) inference capability using for example convolution neural network (CNN) models, or groups of such elements, which are organized to perform one or more computerized function or task and/or provide at least one output or result. For example, the mobile executable software may be considered as one or more software components organized to provide the services (e.g., self testing, user assisted testing, machine-to-machine testing). Other examples may include server components which may be logical organizations of services, for example communicating or receiving requests from POD, kiosks, etc., or a neural network inference component that makes inferences on the probability or recognizing a defect in an image, etc.

Herein, “software components” is used to abstract implementation details so that those skilled in the art could implement the component in a variety of ways and with various granularity levels on one or more hardware devices and/or hardware processors. A software arrangement is a typical organization of a plurality of software components, some running permanent or quasi-permanent instances of software, such as a 24/24 server services, other component being ephemeral instances such as a mobile executable software component transactional instance of a diagnostic software running on a POD, the plurality of software components being distributed among a computing cluster wherein, for example, one or more components may be set to be executing on the server, one or more components may be set for being executed on the POD, some other components may be set for being executed on the PED, etc. “Software arrangement” is also used herein to abstract some level of implementation details with regards to the respective embodiments of the invention.

In some embodiments described herein, the software arrangements has specific software components that are required to be executed on specific computing device, such as performing the self-evaluation tests must be executed on the POD, and other software components may be executed on one or more possible computing devices, for example providing user instructions may be, at least in some embodiments, made on the mobile executing software on the POD, or possibly on the PED or on a kiosk, or possibly a Point of Sales (POS) system. In the system according to some embodiments, the software components can be arranged for being computed on devices including, for example: POD computing devices, for software components that requires specifically to be executed on the POD; user interface (UI) computing devices, for software components that need specifically to be executed, or rendered on UI capable elements of the system; camera enabled computing device, for software components that needs specifically to be executed on a computing device operatively in communication with at least one camera; any of the above devices or another computing device, for software components that can be executed on any computing capable elements (or on computing devices that have specific capabilities not available any of the above mentioned devices), including the POD, PED, kiosk, server, POS, UI or other computing device, for example decision making, neural network inference, etc.; server computing devices, for software components that should be executed only on a server in the system, for example data storage, sensitive information handling, etc.; and/or companion device for providing or assisting with part of the user experience, may be for example a generic computing device or a camera enabled computing device such as a laptop, a desktop, a tablet, a new smartphone, a wearable device or an embedded computing device such as portable inspection device (PED), a kiosk, a POS system.

Part of the software arrangement includes one or more software components running on the POD as mobile executed software. This mobile executed software may, depending on the embodiments, be implemented in various forms, namely, for example: a web-application, which is typically software/scripts/instructions executed in response to a browser accessing one or more web-server that is capable to serve such instructions (e.g., such as HTML, CSS & Javascripts); a full mobile application, which is software downloaded from either the Apple Store, Google Play Store, or side-loaded by another mechanism in order to be executed on the POD, which may run native code or sometime emulated codes, including web-based technologies; a “fast app”, e.g., named Instant App by Google (Android) and App Clips by Apple, which are simplified versions of mobile application software temporarily accessed from the Apple or Google Play Store which are able to be executed on the POD and will typically be automatically discarded after use (i.e., they will not reside on the device after use). They are constrained in features and size.

Web-applications are very convenient as they simply require accessing a web server and can be performed even when no user is signed on the device with a valid OEM/OSP store account, however they have limited access to several of the system calls and therefore provide limited test abilities. Full applications provide the most exhaustive feature sets, at the expense of customer experience which requires them to be signed-in, go to an app store and fully download an application before executing it. Fast-apps are hybrid as they are easy to access, but limited in functionality and still require the user to be signed into the device.

Except for some specific functions where technology or permissions are limited, embodiments of the present invention core may be instantiated using any of the 3 different mobile executed software described above. For example, some features may not be available to a web browser and only be accessed applications running on the POD. For such an embodiment, using fast-app or installing the full-application software would be required.

Some embodiments of the invention may be instantiated web-app only and some other embodiments may be instantiated using web-app for some functions, using fast-app for other functions or use-cases, and using the full app for other functions or use-cases, as the case may be.

The present invention's embodiments are sometimes enhanced by a visual inspection device which may take the form of a kiosk with at least one camera or a PED and others.

The present invention's embodiments are sometimes enhanced by the use of a “mobile device management server” which provides services as authorized by Apple or Google for managing a fleet of devices, including applications, settings, and configurations on a fleet of devices, typically used in large organizations that handle plurality of POD. These systems are typically used for example to ensure that the device ownership and control remains to the organization and not to the employee or device user. They can provide a plurality of management services, such as disabling a device, installing an application, restrict use, remotely deleting information, etc. These services are accessible through services interfaces, such as REST API and similar methods. Embodiments of the current invention may benefit from some of such services namely during device ownership transfer.

The software arrangement described in the various embodiments aims at providing novel solutions for tasks such as, for example: capturing privileged device information, including serial numbers and identifiers, such as IMEI and specific model information which are not accessible programmatically; capturing privileged user information, including name, email and other information that may be stored on the device but not accessible programmatically; reliably relating or pairing an identifiable device to an identifiable user; and/or providing a PoSE (including reasonable equivalence) for being able to certify that an identified device was, at a given time and date, securely erased and free from sensitive user information, which may also include certification that the device is free from usage limitation locks.

Software arrangements described herein may at some early point create on one of the computing devices a data container such as a data structure, JSON, database record or other similar data containers, for containing the information about a POD, a POD evaluation, and/or an examination or transactional instance. The data container will typically use a data organization structure, for example using device attributes (as previously described) which may be in the form of keypair elements. The data container may in some embodiments be exchanged by the computing devices, for example by transferring the JSON object, but other embodiments may use service interface for storing, accessing or querying the existence of an information, for example, using a REST API. The data container will typically include an identifier which can relate to the transaction instance, which may be a random, sequential or otherwise unique, or any existing identifier available such as for example the MAC address or the IMEI (when available).

### Controlled Wi-Fi Access Point

In some embodiments, it may be preferable to offer or control a Wi-Fi access point (commonly known “hotspot”) at least for POD access to the internet, as this may provide additional control and/or information that can be useful to solve some of the problems described herein, such as capturing the POD networking information (e.g., such as MAC address) which can only be obtained from devices connected to the same subnet, further validation of the POD IP address, limiting POD access to certain sites which could cause additional network traffic, limiting POD access to certain services that could be used for tempering with the system, for example “screen sharing” over network for tampering with relevant information displayed on the POD, etc.

In some embodiments providing a Wi-Fi access point, one of the computing elements located nearby the POD, such as the kiosk, a PED, a POS or a router, is operatively in communication with an available Wi-Fi circuitry, for example as it may be provided by several manufacturer either using a chipset for example Qualcomm™ combined with external electronic components such as antenna, or provided directly on some single board computers, such as Raspberry PI™, or some system on chips, or as external components such as embedded Wi-Fi circuitry embedded on a USB dongle, a daughter board or other connectable board to the computing element serving as the Wi-Fi access point.

Some embodiments providing a wireless access point may have access to 2 Wi-Fi interfaces, for example allowing one interface to be connected to a local LAN which typically has its traffic routable to the internet from its gateway/router, and the second interface being used to provide the Wi-Fi access point for POD (and possibly PED or other companion devices) to connect to. Alternatively, the system can also be implemented by having one Wi-Fi circuitry and one wired circuitry (wired Ethernet interface) connected to the Internet.

In embodiments providing wireless access point for POD connectivity, the computing element's operating system is typically configured to bridge or route the traffic from the connecting POD to the Internet, and may also provide other services such as DHCP for providing IP address leases, DNS services for translating domain names to IP addresses, etc.

In some of these embodiments providing wireless access point for providing POD connectivity, the operating system of the POD may be configured for example using iptables, a well known Unix and Linux user-space program for configuring the kernel firewalls and routing rules, and/or DNS sinkhole, such as “pi-hole”. Similar technologies have been developed for instance for parental control, preventing access to certain sites by certain users, or time of day, for example. Captive portal technologies may also be used, with or without the other security enhancing software. Captive portals allow a network to route traffic in a certain specific way, for example forcing typical http (web) traffic to be served by a “portal page”, which may require authentication, provides instructions or warning, before allowing a user to access other areas, possibly still limited, of the internet. Captive portals are widely used in hotels when guests first connect to the network. Secured embodiments using these limitative, security enhancing technologies described herein will use “controlled Wi-Fi” to describe such controlled access points. Embodiments may use these technologies, configurations, software or software component equivalent for adding security limiting access to certain IP addresses, subnets, domain names, etc. Controlled Wi-Fi access points may also provide temporary, user limited, or other condition-based access. “Controlled Wi-Fi access point” may be described as “a network access point for which a controlling computing element has the ability to restrict network access to certain domains, subnets, IP addresses or ports including the ability that such restrictions be function of conditions such as user, time, connecting device type, ongoing system status, etc.”.

Embodiments of the present invention may use controlled Wi-Fi access points for a plurality of purposes such as, for example, network security, reducing non-authorized access to the network, preventing computing element to be used to access the local network, preventing system tampering, and the like. Using a controlled Wi-Fi access point prevents users from using screen sharing services, for example by joining a virtual conference room, which could allow a user to display information from another phone for it to be captured by the physical imaging device camera.

### Navigation Based Information Capture and Recognition

It may be required or useful to access information that is only visually accessible (or otherwise difficult to access) on the device after the user performs certain navigation operations. As mentioned above, operating systems often hide or render certain information non-accessible from the application software layers, web or native applications (e.g., not programmatically accessible). Herein, such information is referred to as privileged information or navigation-based information, which includes privileged user information and privileged device information.

One reason for that may be improved privacy, wherein the operating system prevents access to, for example, the IMEI or other unique identifiers of the device. Other reasons may include lack of interest in developing and maintaining APIs for accessing certain specific information. This prevents applications and eventually servers and websites from uniquely tracing a user or device. However, in the ecosystem that requires device ownership transfer, many of these information is legitimate and required.

Privileged information may include: device identifiers, such as IMEI (including IMEI2 for devices supporting multiple IMEI), MAC, Bluetooth identifiers, device serial numbers; device information, such as model number, storage capacity; user identifiers, such as name, email, account information; and/or device health and status information such as battery lifecycle status, status of OEM/OSP protection (i.e. Apple Care), etc.

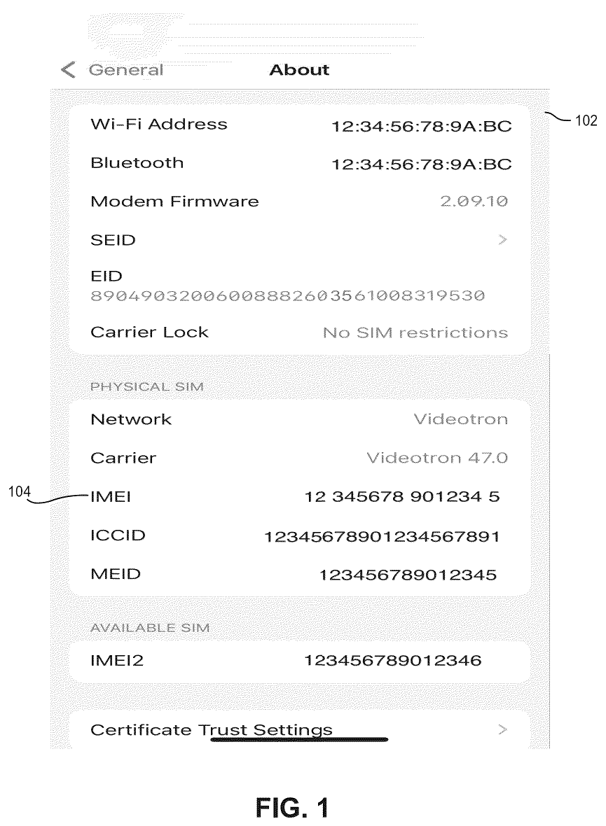

Some privileged information may sometime be accessible by software, but sometime may be incomplete or remain hard to access, for example it may be useful to verify a model number and its commercial name from visual information readable for example in the POD's system setting screen. FIG. 1 shows an example POD system setting screen 102. System information, such as, for example, the IMEI 104, are visually readable on screen 102.

Example embodiments of the present invention provide improved solutions for facilitating, capturing and recognizing navigation-based information by using digital imaging methods which can be either rendered by using either camera-based information recognition methods or framebuffer-based information recognition methods.

### Navigation Based Information Capture Using Camera-Based Imaging

In order to circumvent the problem posed by the limited accessibility to some device identifiers such as the IMEI, while maintaining a good user experience and avoiding probable mistakes or intentional fraud, some embodiments of the present invention provide methods which may use unique device identification possibly by association of other identifiers, using physical imaging of the displayed information for further recognition, defects, micro-defects and micro-differences analysis, etc.

Example embodiments using camera-based information recognition methods are organized in a way so that, when a navigation based information is necessary or desirable for example during a POD assessment/evaluation process or another mobile identification process, the user is guided, typically by following a series of instructions displayed or spoken from at least one software component being executed on the POD or on one companion device, wherein the software component communicates the steps to be performed on the POD prior to the camera-based information recognition of the navigation based information screen. Once the navigation steps to arrive to the desirable information have been performed by the user, the user may be instructed to place the POD display in front of a camera operatively in communication with the system, which may be a companion device camera, and the system may take at least one digital image or video of the POD information screen using the camera. Using at least one of the captured digital images, a software component which may be instantiated on any of the system's computing device, may, by means of programmatic or artificial intelligence, identify within the at least one captured digital image (which could be a result of decoding video into frames), the desired information.

For the system to work, it is necessary that the hardware component arrangements be able to communicate, either directly in a peer-to-peer mode, or indirectly, through for example access of a remote server (including proxy). For this to work, the Internet is obviously a common communication network, but other networks or communication mechanism can be used, namely Bluetooth or Wi-Fi (direct).

In a more detailed exemplary embodiment using physical imaging methods for capturing navigation-based information, for example in a system that desires to acquire the IMEI and the model identifier, the system could be designed as follows: the system may guide the user to access or download the software components that contain the mobile executable instructions, for example, as described earlier herein, a web-application or a native application including a “fastapp”. This may be made by having the user directly access an application store or a URL or having the user scan a QR code, an App Clip code or other URL (Universal Resource Locator) container, possibly from printed material or from a companion device such as a trade kiosks, a PED, a POS portal, or from an online website.

In some embodiments, the system may include pairing with a user identifier. Such embodiments may for example be implemented with a user pairing means for pairing an identifiable user with a companion device and a POD. Such means include for example:
asking the user for a reachable user identifier such as an email or cellular number capable of receiving an SMS message and the system, using this reachable user identifier, sending a unique identifier, or a code, such as a user typable PIN, possibly embedded in a URL, and, this unique identifier, when used (clicked or typed) will allow the system to pair the user, the companion device and the POD;
asking the user to send an SMS or scan a QR code or NFC for sending pre-encoded SMS to an automated SMS receiving server, which upon receiving an SMS and associated information including the mobile telephone number of the user (sending party), can now send a pairing code, or display such pairing code on a companion device, which could have been made associable by having an identifier embedded in the pre-encoded SMS; or
using a sign-in method, such as Apple sign in.

In some embodiments requiring some tests to be performed on the POD, a mobile executable software component is made accessible, for example by means of URL possibly sent by SMS or QR encoded, which upon execution (including script interpretation) on the POD, in the form of web technology or native application software (including “fastapp”), performs possibly some automated tests and some user assisted tests, and the results of the tests, for example user tests such as touching a plurality of areas on the screen to determine if the touch screen is in working condition, may be used by the system for determining if the device is in working condition.

For gathering the required information using a camera-based information recognition method, a mobile executable software component (which can be the same as above) will at some point run in conjunction with a camera enabled companion device (such as a PED including another user owned device, kiosk, etc.), which contains at least one software component related to the system. For simplifying the user flow as well as enhancing security in the process, the software components may have means for device-to-device pairing, which is a method allowing at least one device to uniquely recognize the other device. Pairing methods may include code-based entry following a SMS message sent to one of the devices and entering a code on the second device, hotspot pairing such as Wi-Fi Direct or similar methods, bluetooth pairing, pairing using QR codes, pairing using OCR of identifier including IMEI, or other recognizers as described in, for example, U.S. application Ser. No. 17/534,092 filed Nov. 23, 2021, the entire content of which is herein incorporated by reference. Once paired, the POD and the companion device are operatively capable of communicating, either directly for example using bluetooth, or using a common network such as WI-FI, or indirectly, for example using a common messaging server, a proxy or a common control server which remains accessible by both devices, typically by using the internet.

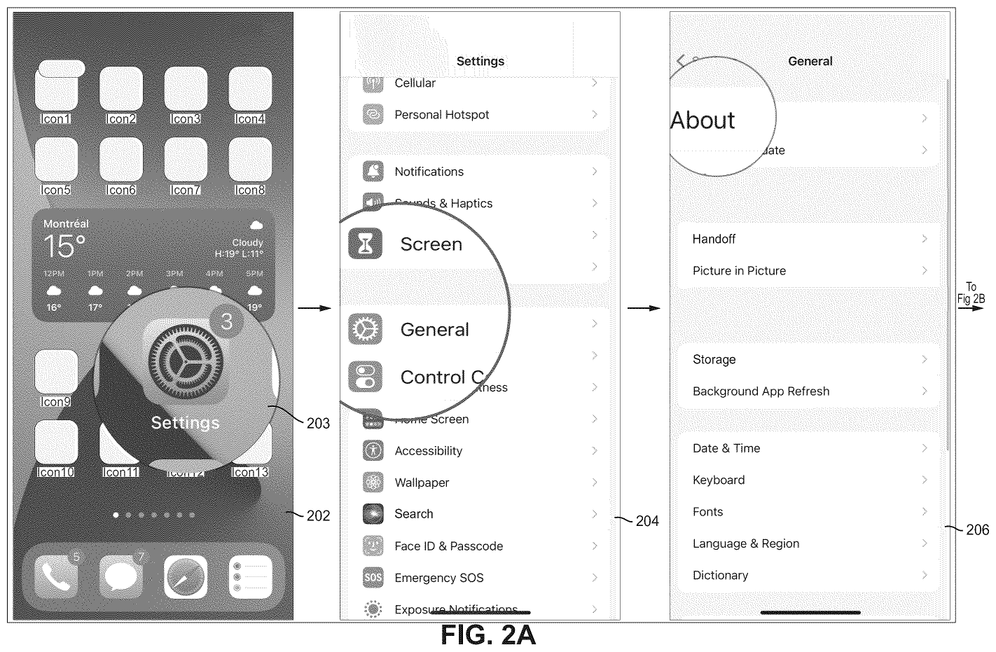

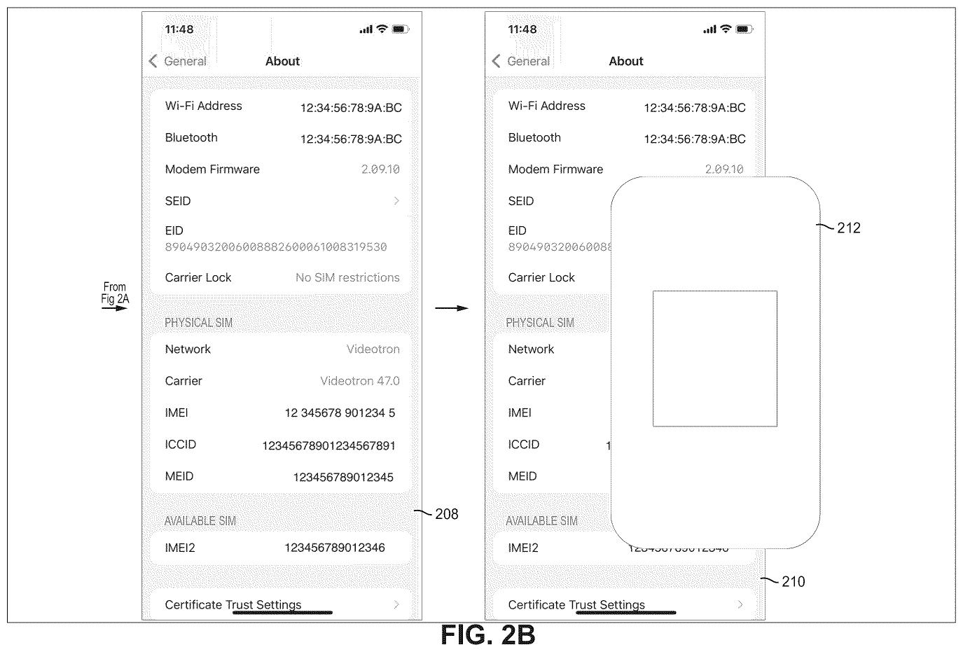

Once it is necessary or desirable for the system to acquire the navigation based information, for example the IMEI, the user is instructed by at least one of the active computing devices, which can be one or a combination of the POD, the companion device or a third device for as long as such device has at least one means to provide user guidance, such as display, sound or video and that it is operatively in communication within the system for providing the navigation instructions. The navigation instructions can be multimedia instructions but at least one of displayed text, spoken instructions, displayed images, displayed video with or without audio, etc. FIG. 2A and FIG. 2B (collectively FIG. 2) illustrate an exemplary navigation instruction using images and text displayed on the companion device, such as a kiosk, a PED, POS or a website. In the illustrated progression of navigation instructions, the companion device displays an image of a home screen 202 with an overlayed highlighting 203 the settings icon, an example settings screen 204 with the highlighting on the general option, an example general setting screen 206 with the about option highlighted, an example about settings screen 208 and then an integrated image 210 of the same about setting screen 208 overlayed with an image of another device 212 capturing an image of the IMEI.

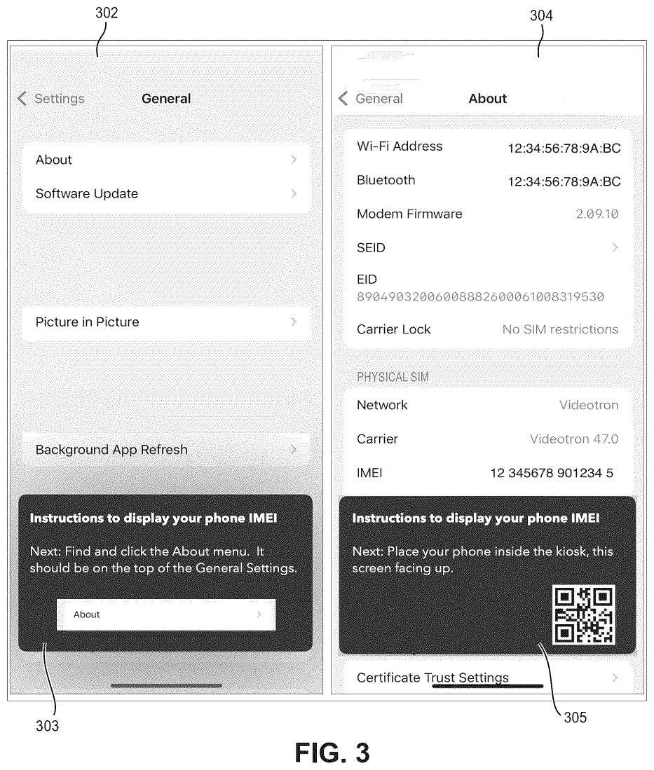

In an alternate exemplary embodiment of the present invention, the mobile executable software may start a Picture in Picture type of window which overlays on part of the display of the POD while providing the navigation instructions, as further described below. FIG. 3 illustrates an example PiP window 303 being overlayed on an example general setting screen 302 of a POD instructing the user to proceed to the about setting screen, thereby causing the next screen, the about setting screen 304 to be displayed with another PiP window 305. In the illustrated embodiment, the PiP window includes a QR code that can be captured by a camera of a companion device.

An alternate exemplary embodiment of the present invention may use the USDD code *#06# when only the IMEI is required, in such case, the navigation instructions may be: “Please dial *#06# using your owned device (POD), this will display your device unique IMEI, then, place your device (inside the kiosk/facing the camera/etc.) so that we can take a picture of your IMEI.”

Because the navigation instructions require access to certain system information screens containing the relevant information differs depending on the model and/or operating system of the POD, some embodiments providing navigation instructions are organized to select or adapt the navigation instructions based on the POD make, model, operating system and/or version of the operating system. For example, the method for accessing a screen that displays relevant information such as IMEI and serial number differs between Android and iOS, but also may differ between specific versions of iOS. To achieve this, prior to the rendering of the navigation instructions to the user, the system must have identified at least the POD manufacturer, model or operating system.

Once the relevant information is displayed on the POD's screen, the navigation instructions may instruct the user to present the device to one of the system's connected cameras so that the system can take a digital image or video of the displayed screen.

From at least one of a digital image captured or from a video frame of the POD displaying the relevant information, several methods can be used to extract the relevant information, such as OCR, neural networks and pattern matching to identify and/or extract for example the POD's IMEI number.

Additionally, some embodiments of the invention may use the physical imaging methods described herein, possibly enhanced with navigation guidance, including possibly PIP guidance, to gather other type of information, for example user specific information. In such embodiments, the navigation instructions are adapted to navigate the user to the proper menu screens that display such information. For example, user identification may be performed on iOS device by selecting the username top menu option, then selecting name, phone numbers, email, etc.

The system aided with the pairing method described above is now capable of associating the extracted IMEI with the inspection device (i.e. kiosk, PED, etc.), or, in some embodiments, directly to an identifiable user (e.g., owner of the device).

Embodiments with device and user identification may use for example an authentication method related to a user identity. In embodiments described above, the user identification mechanism uses for example SMS or email pairing method which requires a unique identifier, for example a code, to be typed or recognized by means of user input (e.g., keypad, touchscreen, including the POD's, PED, or kiosk, or tablet touchscreen operably in communication with the system), or recognized, by means of for example optical recognition.

Alternate user identification methods may be used, for example, some embodiments may be designed to use some POD's manufacturer's services, such as Google OAUTH 2.0, “Sign in with Apple”, or social media OAUTH or similar identity platforms such as the ones provided by Facebook™, Twitter (now X™), LinkedIn™, etc. In such embodiments using a third-party authentication service, the software component being executed on the POD will implement and use service interfaces to a third-party authentication server, for example using REST APIs, as described by the API specifications of the respective method used. For further clarity, these and similar systems are referenced: Sign-in with Apple https://developer.apple.com/documentation/sign_in_with_apple/sign_in_with_apple_rest_api; Google OAUTH 2.0 https://developers.google.com/identity/protocols/oauth2; Passkeys password less authentication methods or frameworks such as proposed by FIDO alliance (Fast ID Online) https://fidoalliance.org/developers/.

Embodiments of the present invention may use one or more possible user identification methods for ensuring that, at the time the user identification method is used, the identifiable user is the person in control of the POD.

Association of a POD device with an identifiable user is useful for being able to provide better customer experience as well as diminishing the occurrence of fraudulent use of the system, for example, the trade of devices. For example, in some embodiments using physical imaging for information capture, it may be possible that the relevant information captured, such as the IMEI, may indeed be from a POD that is under the control of the identifiable user, but may not be from the POD that actually is running the instance of the mobile executable software. A misbehaving person may for example wish to trade a POD say IMEI_A, which has defects or malfunction, and use IMEI_B to perform the testing in order to hide the defects or the malfunction.

Some embodiments of the present invention are configured to prevent such “bait and switch” misbehavior by having added to the process a further validation element designed to ensure the adequate identification of device and user and their association with the running instance of at least one software component executed as a mobile executable software.

An embodiment providing such protection against “bait and switch” can use a triggerable action that causes a detectable response on the POD, which may be for example visual, vibrating or audio, in order to assert that the POD from which the physical image is being or was just captured is indeed the same POD that is running the associated transactional instance of the software component. For further clarity, the system may be designed or configured to act in a way so that after having captured one or more digital images of a POD, the system, controlled or in coordination with the running associated transactional instance of the software component, triggers an action that causes a observable consequence that the POD is indeed the POD that the image was just captured of.

A more specific example of such embodiments may be implemented by sending notification by means, for example of push notification or SMS text, which in turns causes the POD to react with an observable consequence of the triggerable action in a way that is detectable by at least one of the computing element of the system operably communicating with sensing electronics, in this case a camera, the computing element being capable to observe and validate by taking subsequent digital images of the POD and analyzing at least one image, for example using programmatic or neural network inference. Alternate triggerable actions may be using an associated transactional instance of the software executed on the POD to trigger, at or just after the digital image has been obtained, an audio signal to be played and recognized, a LED flash or flash sequence, a vibration or a vibration sequence.

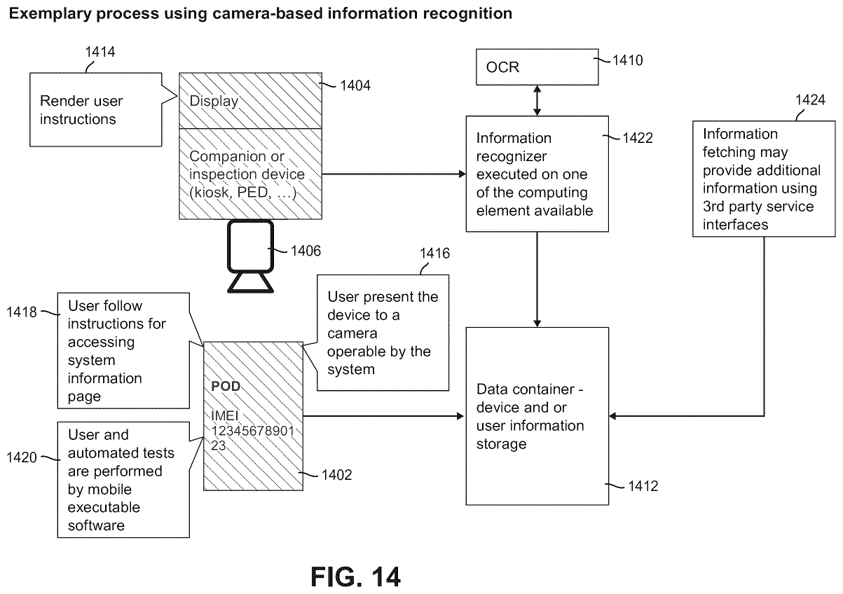

FIG. 14 illustrates an example camera-based information recognition used in some example embodiments. A companion device 1404 with a display and a camera 1406 is used to receive navigation instructions (for example, as described in relation to FIG. 2) 1414 that are shown to the user on the display. The POD 1402 is readied 1416 for image capture by the companion device. At 1418, the user follows navigation instructions (e.g., displayed on the companion device 1404). At 1420 the user may, responsive to navigation instructions, run one or more tests of the POD by mobile execution software. When the sought information, such as the IMEI, is displayed on the screen of the POD 1402, the companion device captures an image of the POD screen and uses OCR 1410 to detect 1422 the IMEI in the captured image. The detected information, the companion device information, user information if available, and any other information obtained from a third party server 1424 may then be stored in a data container instance for the transaction.

### Navigation Based Information Capture Using Framebuffer Access

While camera-based information recognition of POD described herein provides novel and astute methods for capturing privileged information that are hard to access or not accessible otherwise, example embodiments of the present invention may further provide means to perform similar information extraction without using a camera on a companion device, which may be preferable in some instances. These embodiments use what may be referred to herein as framebuffer-based information recognition methods.

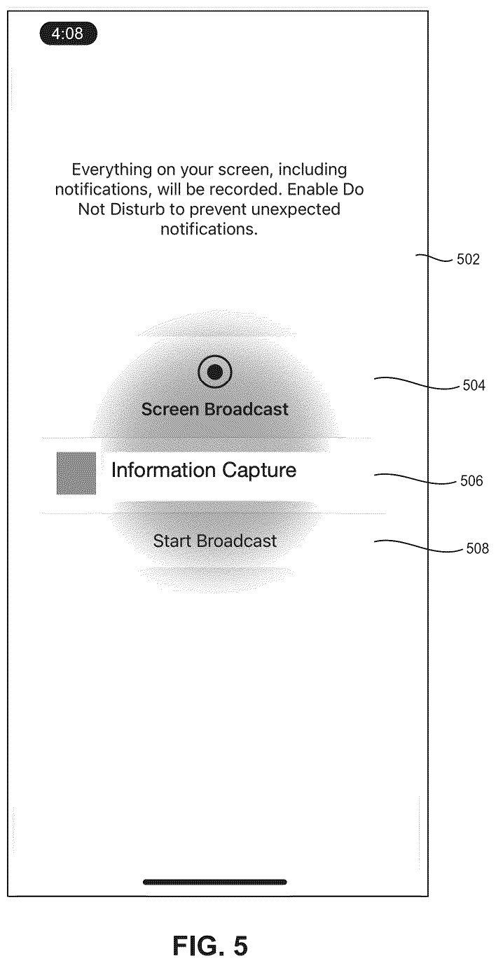

Embodiments using framebuffer-based information recognition methods do not require a camera enabled companion device (but the companion device may still be helpful, for example for providing better user guidance). Such embodiments, instead of using a physical camera from a companion device, will use digital capture methods of the POD's display. Digital screen access methods have been implemented in a plurality of ways in a variety of systems but conceptually functions by having software, typically but not necessarily implemented at the operating system or driver level for ensuring user privacy, that is capable of accessing the physical display memory or framebuffer of the display of the device, or a copy or mapped memory of, and capturing or making at least part of this memory for further processing. These techniques may be instantiated in a variety of ways, including up to the old “print screen”, but more recently known as “broadcasting”, “screen capture”, “screen sharing”, “screen mirroring” and “screen recording” and the likes. To perform any of these, a software component must have a read access, direct or indirect, at least one framebuffer of the display (active or cached). As such, a direct frame buffer access would be for example determining or asking for a memory pointer which directly points to a framebuffer or a subset of. Indirect access on the other hand would be accessing the framebuffer using for example an operating system or driver function that acts as an intermediary between applications and the framebuffer memory. While framebuffer access existed for a long time, more recent examples of such method are encapsulated in frameworks or operating system calls in order to control or limits its use, for example ReplayKit™ on the Apple IOS which provides a framework for applications to access/record the screen after the adequate permissions have been granted by the user. FIG. 5 shows an example POD screen 502 that provides a framework for applications to access/record the POD screen after the adequate permissions have been granted by the user using an example screen broadcast feature 504. An application name or the like 506 informs the user that the screen will be shared (e.g., access to framebuffer provided in order for an application to capture content in the framebuffer), and a button 508 enables the user to provide input authorizing the sharing/access.

Some embodiments of the present invention are able to perform digital imaging of the navigation-based information capturing without a physical camera as the framebuffer access provides the system with the necessary information to perform directly the recognition of the information, as furthermore described herein.

Some embodiments may use distributed computing including for framebuffer-based information recognition, for example, by implementing on one of the network-accessible device to the POD a screen sharing server, such as Apple's Airplay™ Server, which in fact acts as an external screen recorder with framebuffer-based information recognition capability. Even in this embodiment, the POD's framebuffer is used (indirectly) by the operating system in order to stream a media containing the information of the framebuffer, possibly using video compression algorithms such as MPEG or other.

Embodiments needing access to framebuffer information may require a specific permission in order to do so, as shown, for example, in FIG. 5.

Some embodiments whether using physical or digital imaging methods may ask the user for a signal when ready, such as pressing a button, or for embodiments with devices that possess or can access the adequate computing abilities (for example for embodiments arranged in distributed computing), the detection of the relevant information may automatically be performed, for example by using programmatic or artificial intelligence means of object or feature detections possibly combined with OCR techniques. Ultimately, whether the image containing the navigation-based information was acquired by camera-based information recognition or framebuffer-based information recognition method, an information recognizing technique is applied by a software component residing on any computing device, for example using OCR and matching pattern for recognizing which part in the image truly contains the desired navigation based information, such as looking for an IMEI pattern within the recognized text. The recognized information may then be stored in association with the appropriate device assessment session, for example by means of JSON key pairs and/or device attributes as described, for example, in U.S. application Ser. No. 17/534,092.

Some embodiments using framebuffer-based information recognition may enhance the user experience furthermore by using Picture in Picture technology. For example, a mobile executable software on the POD may, after requesting access to framebuffer (e.g., screen recording), start a Picture in Picture window that will be guiding the user. The Picture in Picture guidance may be provided by populating the window with text, images or full video accompanied with spoken instructions.

Additionally, the PiP guidance software may work in conjunction with screen recording and provide intelligent instructions which, for example using feature recognition techniques, so that the guidance instructions are interactive as they follow the user pace and could provide further assistance when a user seems confused. In such embodiments, in the example of gathering the battery health information, which typically requires a few steps, the instructions could be synchronized as the user progress through the steps, detecting the user steps by analyzing the information displayed on the device and at one or more points in the sequence of steps, adapting the next step in response to the user's input. The adapting may include, for example, detecting that the user selected an incorrect or unexpected option, and adapting the next step accordingly.

A more detailed embodiment using framebuffer-based information recognition may start for example by having a user access or download and execute on a POD a mobile executable software, following any method described herein, such as scanning a QR code which contains a URL causing the download or access of the software component. The software component upon or after execution may perform some self-tests and/or may ask the user to perform some user-assisted tests. When the mobile executable software component needs to capture relevant or privileged information that can be made available on the mobile display by the user after performing certain actions, for example the IMEI (and/or MAC address, carrier information, etc.), embodiments must request a read access to the framebuffer which is typically made by some system call to the operating system which will confirm with the user that the mobile executable software can access the information displayed on the screen, for example as shown in FIG. 5. Following user confirmation, operating systems or driver may respond to the mobile executable software possibly by giving direct read access (i.e., memory pointer) or indirect read access (e.g., through some interface such as functions). From this point, the mobile executable software can recognize or capture information that is displayed on the mobile device display for instance by accessing the framebuffer memory or copies of frames and applying or delegating (directly or to another computing element, possibly a server) pattern recognition techniques, OCR, or AI-trained models for recognizing and/or detecting the privileged information or presence of privileged information or specific screens or features displayed for providing contextual help or guidance to the user. In a specific exemplary example, the method may be used to guide the user to a page displaying the device IMEI, perhaps by specifying the user to Dial *#06#, or to navigate to system settings, and, a software component retrieves from the frame buffer frames, may perform or delegate to another software component possibly on a distinct computing element, which can be a server for example, and upon detection by this software component of features or pattern matching a screen or an IMEI, for example an OCR matching pattern corresponding to an IMEI format, the performing computing element may communicate, store or otherwise make an association between the retrieved IMEI and the transactional instance of the current transaction.

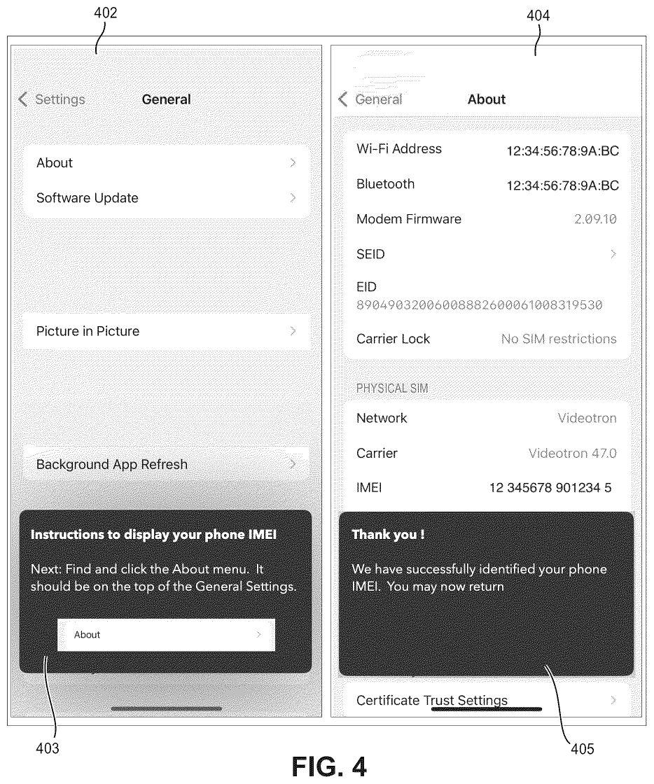

Exemplary embodiments having direct or indirect access to framebuffer information may use that privilege to provide enhanced, contextual user navigation instructions. As a more detailed example, such embodiments may regularly analyze by accessing or capturing information retrieved from the framebuffer (directly or indirectly) and using feature recognition, OCR pattern recognition or AI trained models, be able to determine if the user has successfully performed a certain step, and/or is now at a specific known interface page/menu, and accordingly (in response) adapt, contextually, the information. For example, FIG. 4 shows an exemplary navigation into the system setting screen with Picture in Picture instructions provided by the mobile executable software which, by having direct or indirect access to the framebuffer information and using detection or recognition techniques is able to automatically detect that the user successfully moved to the proper page containing the privilege information, in this example the IMEI and/or other identifiers shown, and, upon detection of the presence of features or recognition of the IMEI, the mobile executable software adapt, using its write privilege to framebuffer (direct or indirect), the contextual message displayed in the Picture in Picture, in the exemplary instance thanking the user and notifying that the information was successfully retrieved. This method is significantly more convenient than existing methods which are often error-prone, for instance many applications today require a user or staff to type-in an IMEI. When possible, this method may also be preferable over camera-based imaging as it allows for immediate information retrieval, constant monitoring of the user progress through the navigation and is able to adapt or contextualize the navigation-based instructions to changing situations.

The exemplary method described above may be used or adapted accordingly to enable the system to retrieve other privileged information. For example, the above description may be applied to retrieve the user name from a different page, or the battery status, etc.

### Embodiments Using Navigation Based Guidance

Embodiments of the present invention may use one or both of camera-based information recognition or frame-buffer-based information recognition methods to acquire at least one image containing desirable information concerning the device or the user, typically the current owner. After acquiring such an image, some embodiments would attempt to recognize at least one information from the acquired image or recognize the presence, or probable presence of such information.

One method for doing so is for example using OCR techniques, for example sending the captured image to an OCR service, such as Google Vision™, and, using the returned value of the recognized texts and then performing one or more pattern matching algorithms, possibly using RegEx (regular expression) evaluation engines, to identify a subset of the recognized text that matches the IMEI standard or other information pattern.

Another method for doing so is to use trained AI agents which are able to recognize features for determining the presence of a desirable information, such as the presence of an IMEI, and then extracting, using OCR techniques which can be programmatic or machine-learning based, such as described herein.

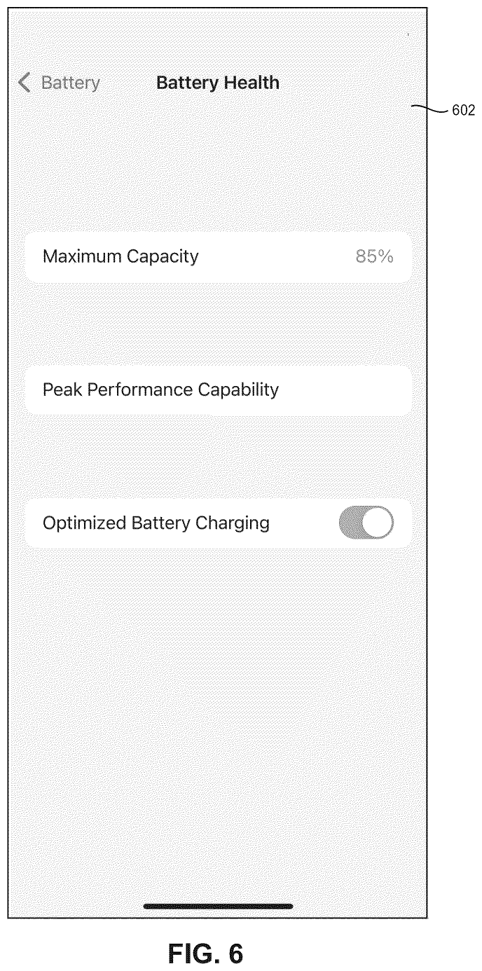

Exemplary embodiments of the present invention can be used for acquiring many other relevant information that the system may desire to know, some which may be located in one or more different menu, or require scrolling, typically inside a system information page such as the phone settings, for example: battery health, for example, on iOS, battery health information can be acquired by navigating from the main settings screen to battery, then battery health to display the battery health info (FIG. 6, for example, shows a screen 602 displaying battery health information); carrier/SIM lock restrictions; carrier activations; and/or MAC, serial number, WiFi, Bluetooth identifiers.

Some embodiments and novelties herein are not necessarily limited to recognizing or identifying POD information but may also be used with mobile devices in relation with the ecosystem. For example, identification of a mobile device IMEI, or device make/model may also be required or useful in the context of identifying the new device recently purchased by a user, and the navigation based information recognition methods can also apply for extraction of such information and possibly associating such information with the transactional instance.

### Navigation Based Information Capture Using Picture in Picture

Navigation based information capture may be cumbersome to some users because they require specific and additional steps that the user needs to perform in order to acquire the desired information.

Some embodiments of the present invention improve the ease of navigation by providing overlaid images, videos, optionally with audio instructions, directly on the electronic device as the user performs the necessary navigation steps. While some embodiments may use any multimedia rendering device operably in communication and in close proximity to the user, such as the POD, another mobile device, a POS, a kiosk, some embodiments may provide user based navigation directly on the mobile device being assessed. Such embodiments are possible when the mobile device has the capability of having more than one application using the display wherein a part of the screen may be used by one application and another part used by a second application.

Such embodiments may provide users with a more focused understanding of the steps to be performed as the navigation instructions are presented directly on the mobile device on which the navigation steps need to be performed.

These embodiments of the invention need some mechanism to access, directly or indirectly, the frame buffer with permission to write on the screen. Direct access to the framebuffer may be provided by using a memory pointer having the sufficient privileges for writing at least part of such framebuffer. Indirect access to the framebuffer may be provided by for example a windowing system, which allow multiple applications to display information, as it is commonly known.

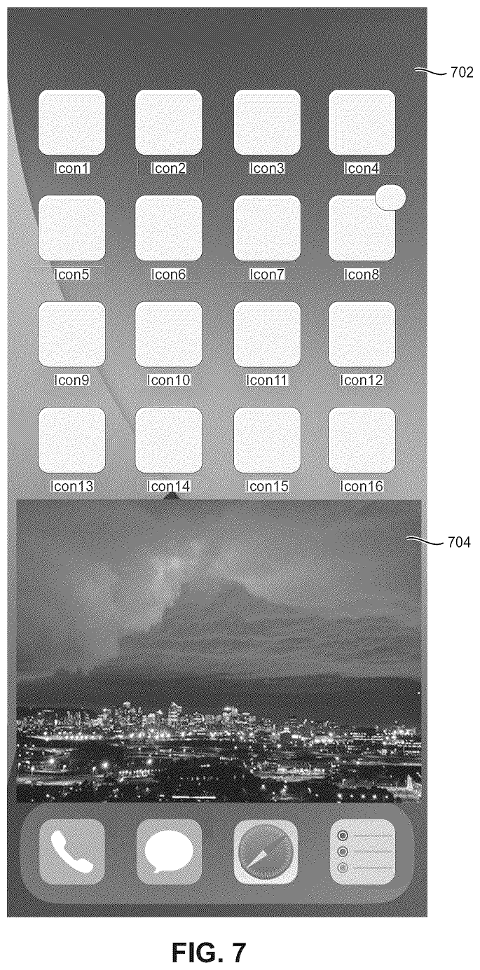

Mobile devices have been more restrictive than typical desktop or laptop with regards to having multiple applications sharing the same display, or segments of the display. However, most recent smartphones and tablets nowadays will support a feature commonly known as “Picture in picture” (PiP), which is often used by users for example to watch a video while doing some other tasks, such as browsing the internet or writing an email. FIG. 7, for example, shows an example POD on which a PiP widow 704 is playing a separate video while a home screen 702 is being displayed.

While video viewing is the most commonly known use case of the PiP feature, they can be much more useful particularly when used with navigation-based instructions and the contextual mode described by some embodiments herein detailed.

Such embodiments will use a functionality known as Picture in Picture (PiP) that both iOS and Android currently provide. Picture in Picture allow control by a mobile executable software of part of the screen, while the user can access or navigate other functionalities provided by the mobile device. This section provides more detailed information about the particular characteristics and variant of PiP for capturing navigation-based information in example embodiments.

PiP allows a part, typically smaller than the balance of the screen, to be controlled by one application and therefore allows the user to navigate within its system on the main display. To enable such features embodiments must first have a writable access to the framebuffer, or to part of. Such access may be provided in different manner depending on the operating system and hardware available. Some may use direct access, which could be in the form of a writable memory pointer to part of the framebuffer memory, but use of PiP platforms will typically provide indirect access to writing on the framebuffer memory. As such, embodiments of the present invention may use the mobile executable applications in a way to provide information to the part of the display, to help the user navigate through the steps needed to be performed to access specific mode or screen for displaying privileged information.

Embodiments using PiP for capturing navigation-based information will have first downloaded or accessed a mobile executable software, which may be a web-application, a native mobile application including MDM application or a “Fast App” application. At some point during execution of the mobile executable software, presumably after having performed some other tests, the mobile executable software may notify the user about the navigation process needed to capture some specific information about the device or the user.

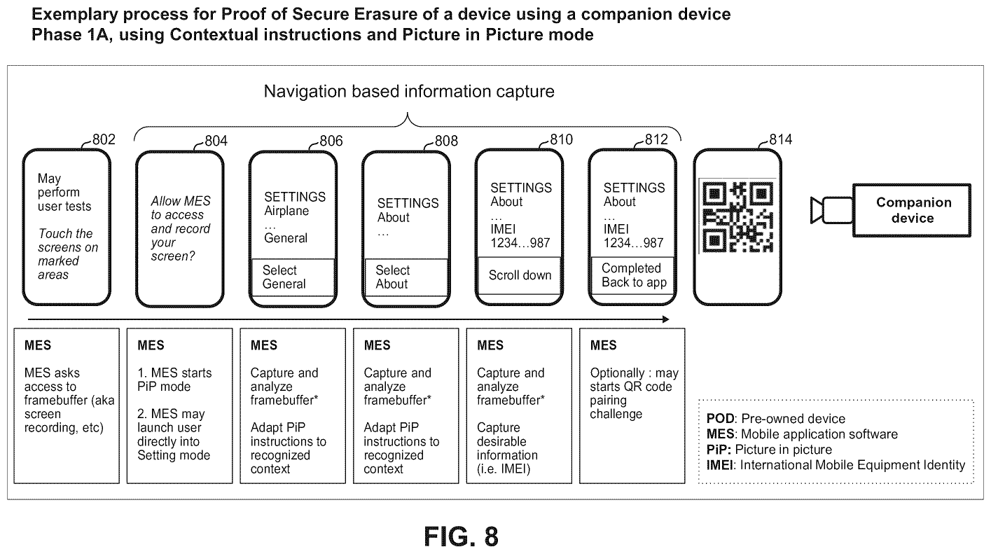

An exemplary embodiment of the present invention using navigation-based information capturing with PiP may be detailed as follows (e.g., process shown in FIG. 8):
A mobile executable software comprising at least one software component is made available and executed on the mobile device and may perform for example some device diagnostics tests, for example asking the user to touch areas of the screen (e.g., operation 802);
If the navigation-based information capture uses framebuffer-based imaging of the mobile device, the mobile executable software would request a read access to the framebuffer (e.g., as described above);
The mobile executable software may provide a context page for the user to understand they will be guided to access certain screens using PiP, and, when the mobile executable software needs to capture the desirable navigation-based information, it will request write access to the framebuffer as shown, for example, in FIG. 5;
The mobile executable software will start the PiP window and may, for example, launch a specific application, such as the phone dialer if the desirable information is accessible by dialing *#06#, or the system settings if the desirable information is within the system settings (e.g., operation 804);
The mobile executable software will start rendering PiP information: possibly as a series of loop guidance instructions such as in a simple how-to video or series of images, or keynotes, possibly accompanied with audio; or, possibly as an interactive and/or contextual guidance instructions by having the mobile executable software recognize, from the framebuffer access, not only the desirable information but also the specific step or screen the user is currently on; and
The user is guided by the navigation instructions provided in the PiP display and, once the system recognizes that the user is in the appropriate screen that displays the desirable information, a copy of the framebuffer is made which can then be extracted by one of the computing elements (e.g., operations 806-810). For recognizing the appropriate screen, the system may implement programmatic detection of features, OCR-based text and pattern recognition, or use AI, for example by using AI feature detection or a CNN image classification model specialized to recognize the screen where the desirable information is located. Any of the computing elements in the system (e.g., the POD, the companion device, or a server) may be used to perform parts or all of the recognition and parts or all of the information extraction (e.g., operations 812-814).

### PoSE—Proof of Secure Erasure

It is often advisable to make a data backup and is recommended to make a data erasure before proceeding with a POD ownership transfer, including a trade, gift or disposal for recycling purposes. Some users may not be comfortable or aware of the steps needed to safely transfer ownership of their device. Also, parties associated with such activities such as retailers, reverse logistic electronic processors, insurance companies and more have a vested interest that no personal data resides on the POD prior to taking ownership or responsibility of PODs. However, ensuring that a device contains no personal information is difficult.

For example, many believe that a device that is “factory reset” do not contain personal information. While this may be true in many instances, there are instances where a device appears or is in a “factory reset” state but that state was not achieved using full data erasure as recommended by operating system designers or device manufacturers.

Such devices may appear as factory reset but are still “tied” to an account owner, for example Apple iCloud or Android user lock. Because there is no simple or standardized method for determining that a mobile device is in a fully data-erased state, embodiments of the present invention use evidence-based approaches in order to ascertain, or at least be extremely confident that devices processed are free from sensitive user information.

In general, different types of evidences may have varying weight in the determination of a proof. This also applies to the problem sought to be addressed in embodiments of the present invention, which implies a third party, independent and computerized determination of POSE that some embodiments of the current invention attempt to resolve. As such, a proof should ideally be unquestionable, but if uncertain, a proof should at least be “more certain than uncertain” that, in some embodiments of the present invention, that the mobile device is actually free from sensitive user information and possibly usage limitation locks. In order to establish certainty or at least a high confidence level (i.e., a confidence level above a predetermined threshold) that a device is securely erased, the PoSE may be based on either at least one unquestionable or a plurality of indicative evidence.

An “unquestionable evidence” is a single, reliable data point which would be sufficient for the system to offer a proof. Unfortunately, these single points of unquestionable evidences are, in the mobile ecosystem, very rare. For instance, an evidence method A may be valid on a specific make/model for ensuring that the device is free from user data, but not free from account or lock information, and it is necessary to check for other evidences for ascertaining that account lock information is removed. For other make/model/OS version, the evidence validation methods may be substantially different.

Use cases may also require the system to apply a different evidence/proof logic. For example, determination of POSE for a device that was previously diagnosed by a mobile executable software, may be different than the use case requiring determination of POSE for the same device if it was previously wiped by the owner.

As such, a novel element of several of the embodiments described herein relies on the ability of the software arrangement of example embodiments to be able to determine reliable POSE from a plurality of methods, evidence capture and/or different evidence validation logic depending on device, user and/or the context. For example, embodiments of the present invention may provide a distinct user experience flow and capture different evidences based on:
Mobile device operating system (e.g., Android vs iOS) for example will dictate different user flow and evidence collection: Embodiments supporting Android devices may use a fully managed MDM method for extracting privileged information IMEI (evidence 1), and ability to install fully managed MDM software (serves as evidence 2); and iOS;
Operating system version;
Mobile device make and model;
Whether the device activated or has it been reset prior to assessment?; and
Local regulations (some countries forbid carrier locks for example while it is permissible in others, which may require the system to acquire additional evidence for example through 3rd party databases/services), etc.

Some embodiments of the present invention may combine a plurality of other embodiments or characteristics described herein for augmented security, reducing tampering, or augmenting the quality of the evidences captured to eventually form reports or PoSE. As an exemplary embodiment, the software arrangement in some example embodiments may include, or access, one or more rules combining evidence of POSE in order to accordingly combine MAC address capture from the controlled Wi-Fi access point (described above) when a POD connects to the Wi-Fi with user-based navigation for capturing using digital imaging of the POD display relevant information that includes MAC address, and confirming that they are the same.

Some embodiments of the present invention aim to avoid ownership transfer of POD that could still be containing personal and/or sensitive information. In order to do so, the system and methods are designed in a way to capture evidence or evidences, for forming a PoSE, that an identified POD has been properly data erased, store the evidence in association with a unique identifier such as the IMEI, and optionally communicate such evidence to a third party, for instance using service interfaces, and optionally act or enable options based on the presence (or absence) of POSE.

As defined in Wikipedia (August 2022), a PoSE is: “ . . . a remote attestation protocol, by which an embedded device proves to a verifying party, that it has just erased (overwritten) all its writable memory . . . ” In embodiments of the present embodiments, the embedded device may be a kiosk, a PED or any device capable of providing certain visual assessments as furthermore described herein, or a third party server such as a MDM server which has means of verifying that all data has been erased on an identifiable POD.

In some embodiments of the present invention, PoSE may include proof that the device is no longer tied to a user account lock, such as Apple FMIP, Android lock, etc.

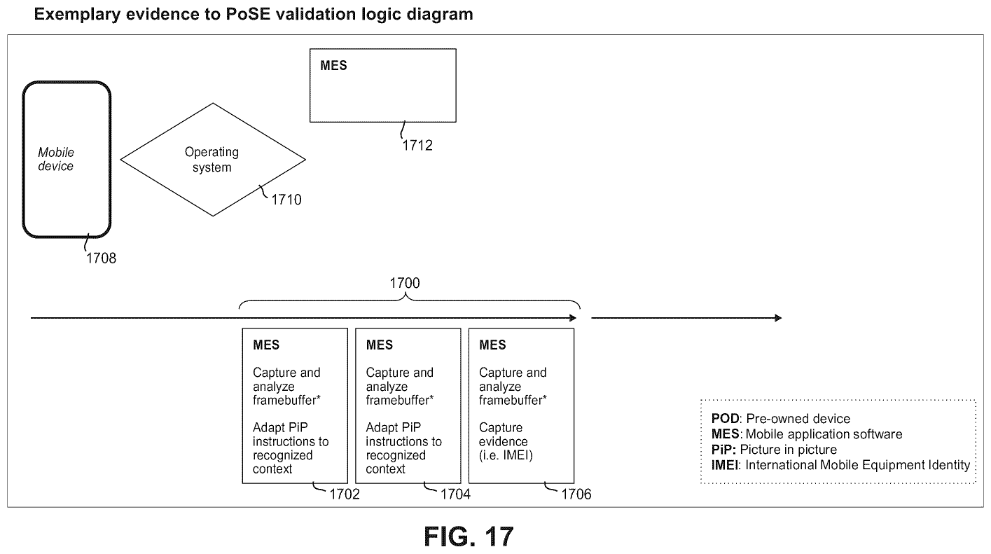

The process for determination of PoSE may differ depending on the make, model, operating system, settings, or use-case. FIG. 17 illustrates an example PoSE validation process 1700. At each of operations 1702 and 1704, the mobile application software 1712 displays navigation instructions in a PiP window on the POD 1708 display, and based on the response received from the user for each navigation instruction, the mobile application software adapts the process to obtain the IMEI or other PII. The adapting may include selecting a different next screen based on the user input received for a first screen. At 1706, the IMEI is displayed and the mobile application captures the framebuffer as evidence of the IMEI. It should be noted that prior to 1702-1706, the mobile application software 1712 may request the operating system 1710 for access to the framebuffer for read (to capture evidence) and write (to write navigation instructions to PiP window).

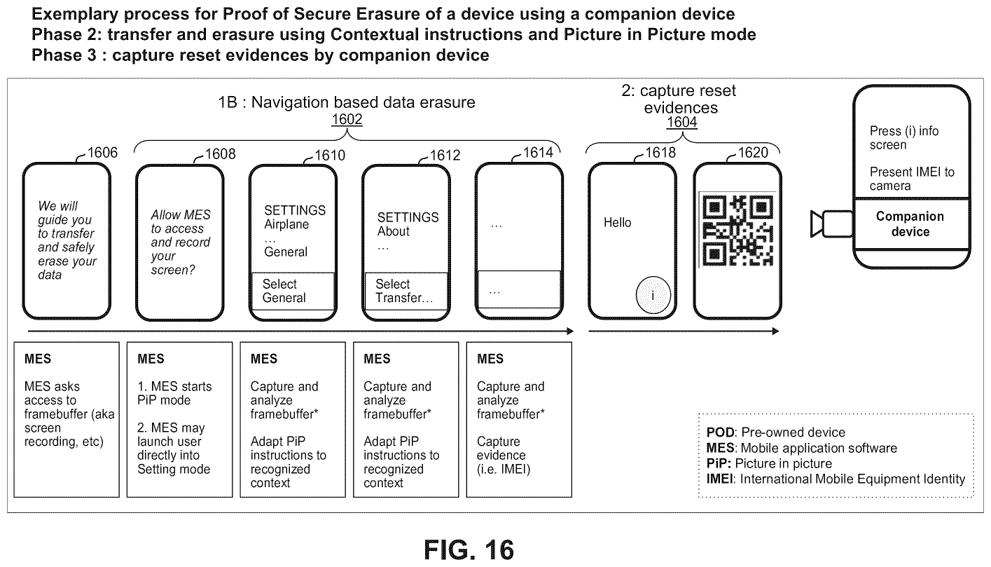

Some embodiments of the present invention may be organized to provide PoSE by having a two or three phase process, wherein the first phase is made before data erasure, a second phase is the data erasure process, which embodiments can assist the user to perform, and the third phase is made after data erasure. FIG. 8 illustrates an example first phase, and FIG. 16 illustrates example second and third phases.

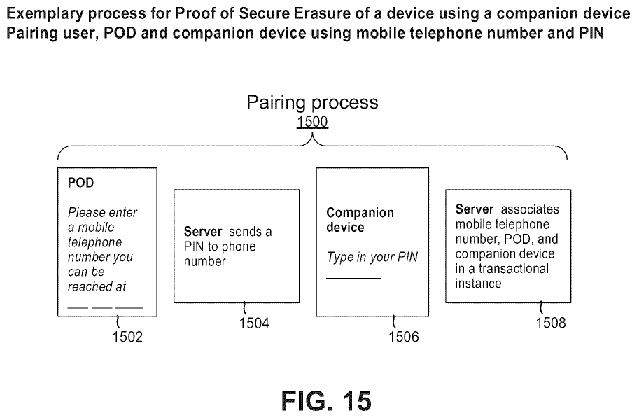

The first phase, illustrated in FIG. 8 may be optional but may provide more thorough and in-depth information and examination about the POD and may include user interface screens to capture some user information such as a mobile telephone number or an email address. For example, at illustrated operation 814, a QR code is displayed on the POD being evaluated for a QR code pairing challenge. At this point, the system may use such user information to perform an authenticity check, such as by sending a PIN to the mobile telephone number which would then be typed in by the user on the companion device. For example, FIG. 15 shows an example pairing process 1500. Process 1500 begins at 1502 with the user entering (e.g., at or following operation 812) a telephone number for the user such as that of the companion device smartphone. At 1504, the server receives the entered telephone number from the POD and transmits a PIN to the received telephone number (e.g., to the companion device smartphone). At 1506, the user receives the PIN and enters the PIN on the companion device smartphone. At 1508, the server associated (e.g., pairs) the telephone number (e.g., identifying the user and the companion device smartphone) and the POD and stores the relevant pairing information in a transactional data structure. This serves a dual purpose: authentify that a valid and traceable user is performing the transaction for reducing fraud, and pair the user, the POD device being examined and the companion device. A first or early step 802 may furthermore include the steps of performing the POD self-tests or diagnostics, and/or user assisted tests and/or advanced device examination using for example machine to machine testing. The examination may include for example one or many of, functionality testing of the POD (e.g., buttons, audio, cameras, network, cellular, digitizer/touch screen, etc.), display testing of the POD (e.g., dead pixels, screen discolorations, screen performance etc. and cosmetic assessment of the device (e.g., cracks or other glass damages, chassis damages, accessories damages, etc.). During that first phase, the examination is typically performed using mobile executing software organized in one or more software components that may perform certain tests automatically, may ask the user to perform certain actions for validating certain functions, and may do machine to machine testing, including device pairing, as mentioned in relation to FIG. 8. During the first phase, typical embodiments when providing device trade-in service will include a quote for the buyback of the device.

Embodiments of the present invention improves conventional techniques by including navigation-based information capture in order to acquire reliable privileged information related to a mobile device or its user, such as a faultless unique identifier for a mobile device, typically the IMEI, MAC address or serial number, which identifier may be used to associate the information obtained from the first phase (e.g., device health information, diagnostic results, cosmetic results, quote information, etc.). In FIG. 8, for example, at operations 804-812 the mobile application software may guide the user to provide a series of inputs on the POD in order to display privileged information such as the IMEI. The mobile application software, at operation 804, obtains user permission to access and record the POD screen. For example, FIG. 5 illustrates a screen by which such permission may be obtained. In some embodiments, the mobile execution software may start a PiP mode on the POD where the navigation instructions to the user are displayed in the PiP window while the rest of the display of the POD is available to respond to display screens and information responsive to user inputs. At each operation 806, 808, 810, the mobile application software, while capturing the framebuffer of the POD, displays respective navigation instructions in the PiP window to prompt the user to eventually cause the display of the IMEI of the POD. At 812, the displayed IMEI is optionally associated with a user by a QR code challenge, by displaying a unique QR code on the POD and using a companion device to capture an image of the QR code.

When information about the POD is captured, collected, created, including as a result of a test performed, the computing devices may directly or indirectly through possible service interfaces, store the information in the data container associable with the device, the user and/or the transactional instance.

In these embodiments using a multiple phases approach, the system, as described previously herein, may render navigation-based instructions to be performed by the user so that the POD displays a system information page containing relevant information, for example instructions on how to dial *#06# or access phone settings so that the POD displays the device IMEI. Then, using a digital information recognition method as described herein, which may be a physical screen imaging method using an associated camera enabled computing device or a virtual screen imaging method using the POD computing device and a mobile executable software having direct or indirect framebuffer access, so that the recognition method is capable of capturing at least image or video of the POD displaying the information resulting from the navigation instructions.

The embodiments may then use methods for detecting, extracting or inferring, using one of the computing device the captured image by using at least one programmatic or artificial intelligence based computing inference method or a combination thereof, which may typically include feature recognition, optical character recognition (OCR) or bar-code recognition or QR-code recognition methods, in order to detect, extract or infer from the captured image the desired navigation based information, for example, analyzing from a virtually captured image or a physically captured image to extract the IMEI # or other identifier of the POD.

In some embodiments a user verification method may include identification using unique codes, for instance the user may be further identified by having the system ask, for example using a software component on the POD or on a PED, kiosk or other companion device, the user phone number. Some embodiments may send a text message containing a PIN code to the user phone number for enhanced security and associating/pairing a user with a transaction and/or a POD.

Alternatively the user verification may be initiated by several other methods, including scanning a unique QR code which causes the POD to prepare a pre-filled SMS containing an identifier to a SMS receiving server in communication with the system, which may be for example using a third party service interface such as services offered by Twilio™, and, when the user sends the pre-filled message, the receiving server captures and communicates through the service interfaces the user phone number and the pre-filled message which would include a unique identifier allowing the pairing of the user, the POD and the initiating companion device that originally displayed the unique QR code.

The method above may also be used for authenticating the user from another device owned or operated by the user.

Once the POD identifier, (e.g., IMEI) has been found for example using a navigation based method described, it will be stored in the data container associated with the POD or the session, for example a data container may contain among other information:

```
{
  “IMEI” : “1234567891011”,
  “_id”: 1ab2c3d4,
  “Quote” : 100.00,
  “Date” : “2022-01-01 13:00PM EST”,
  “Phone” : “514-555-1212”
  ...
}
```

Additionally, information, data or metadata related to the detection, extraction or inference of this identifier may be stored alongside the data container.

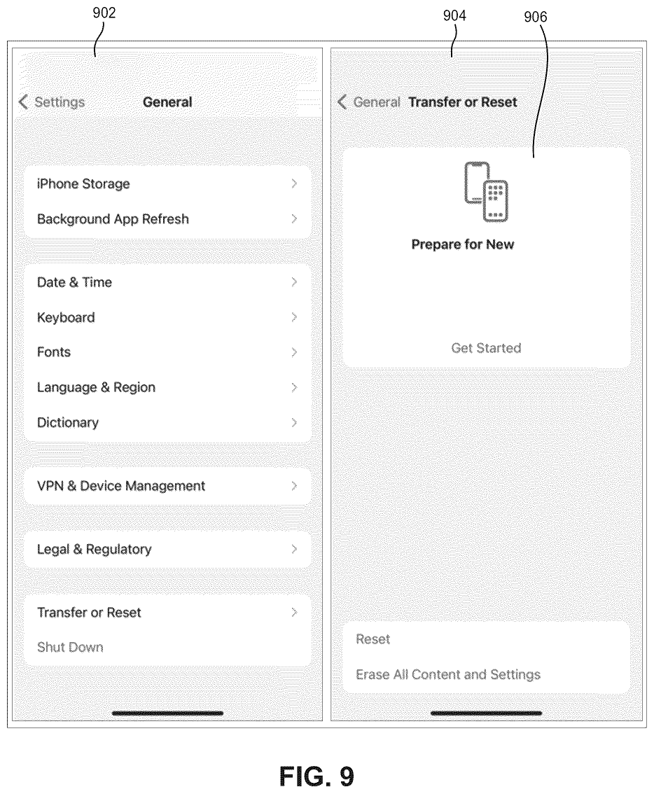

Once the first phase is completed, the user may be instructed to perform required data backup and data erasure using the recommended manufacturer method, such as Apple Quick Start method or Phone transfer. Example phone transfer navigation instruction screens are shown in FIG. 9. Screen 902 shows a setting screen with “transfer or reset” option, which when selected by the causes screen 904 to be displayed providing further instructions 906 on the transfer.

Guidance for data backup and/or data erasure may be provided, for example, using similar instruction rendering methods described for navigation-based information capture. This includes multimedia instructions, text, audio and/or video, and may include intelligent instructions.

Embodiments may also use Picture in Picture guidance described herein for helping the user navigate and initiate the data transfer. Such embodiments will use at least a software component as mobile executable software for displaying in the PiP window guidance information. It is to be noted that the PiP process will be terminated by the operating system once the data erasure process is engaged.

Additionally, embodiments of the invention using frame buffer access may provide improved contextual guidance information, but also capture evidence that the user has followed the recommended OEM/OSP process. Doing so may be performed by mobile executable software executed on the POD having requested and being granted access to the framebuffer (screen sharing, etc.), and, using the capabilities provided by the granting of this privilege, the mobile executable software may then capture copies of the framebuffer and, using at least such image as the user navigates to engage the data erasure process of the POD, the mobile executable software may either send to another computing element of the system the captured image, or a digital notification that such screen have been detected, prior to the mobile executable software instance being terminated by the operating system's data erasure process. When made available by the operating system, a privileged moment for taking such framebuffer copy is when the mobile executable instance is sent a termination signal by the operating system. The received information by the other computing element, which may be a server in communication with the mobile executable software, will be stored as an evidence associable with the transactional instance and this evidence may serve for later determining a Proof of Secure Erasure of the POD.

In an exemplary embodiment an instruction set may be selected and/or adapted based on the POD make/model, the instruction set may be rendered on the POD or on a companion device for guiding the user to the necessary steps for first performing a data backup, then performing a data erasure in accordance with the manufacturer specifications.

While some embodiments may use the first phase described above, other embodiments may start directly or allow users to start at the second or third phase, for example if a user had previously data erased the POD. In such embodiments, the information normally acquired in the first phase is not available and the system must rely only on information available from the second or third phase, which may limit the capturable evidence and may result in less certain POSE. In such embodiments, additional evidences may be captured, for example adding as an evidence a user declaration that the device has been erased from user information according to the recommended OEM/OSP.

Some embodiments may for instance attempt the determination of POSE using visual evidences captured from a camera operably connected to the system.

Some embodiments may collect additional evidences, for example, by querying databases for determination of lock status.

To acquire a reliable POSE for Apple devices, one of the methods may rely on collecting evidences that the device be in a true factory reset state and evidences that the device has no user lock (e.g., iCloud lock) associated with the device.

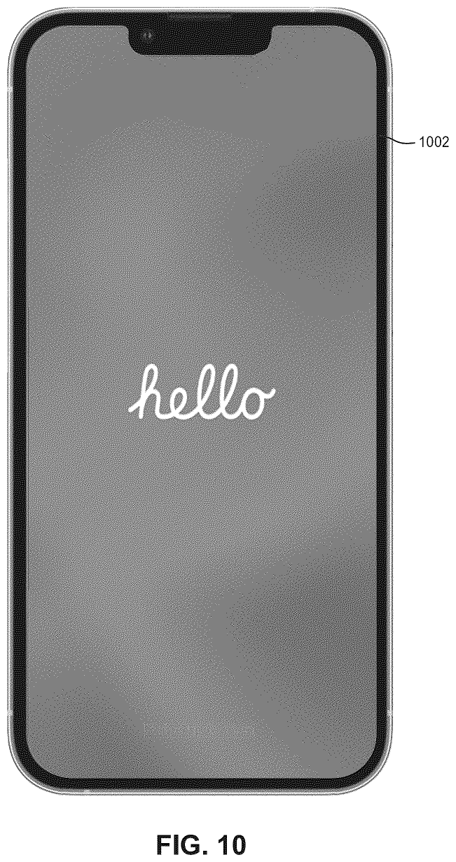

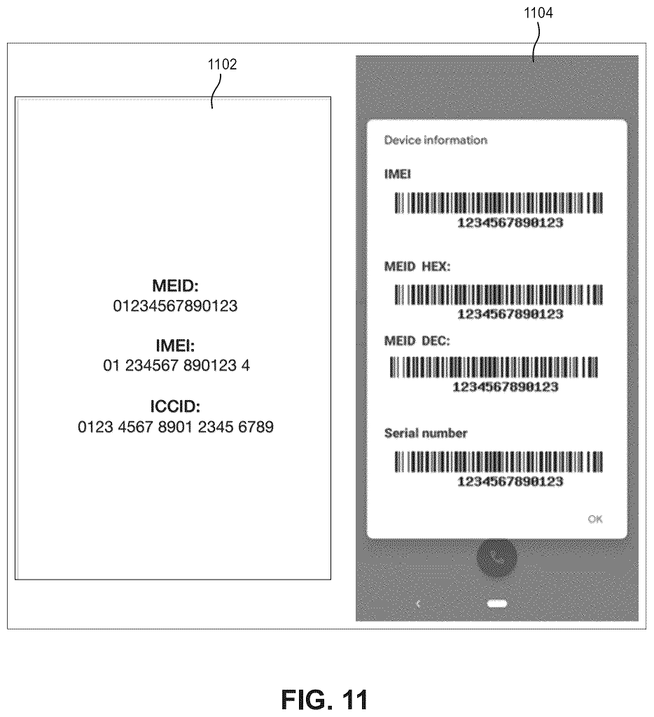

Embodiments providing PoSE for Apple devices are required to obtain a first evidence that a device is in factory reset state. This evidence can be obtained by camera-based information recognition of the device which needs to be powered on and following a user touching the screen or a device button which causes the initial operating system to display a known reset indication screen. FIG. 10 illustrates a “Hello” screen 1002, a known reset indication screen, displayed on a POD. The available screens when an Apple device is in factory reset are limited. At least up to iOS 16, these initial screens include the Hello Screen, an information screen (e.g., screens 1102 and 1104 shown in FIG. 11) and other installation screens.

A good evidence of the factory reset may be acquired by ensuring that the device has a screen that corresponds to either the Hello screen and/or the Info screen, both of which in most recent iOS versions are “live” screens, meaning they can be further observed by video examination or recording.

Embodiments that provides PoSE can acquire and automate the analysis of a good evidence of an Apple device being in a factory reset mode by taking at least one but preferably a series of images or a video of the Hello screens and analyzing, by using programmatic or artificial intelligence or using a remote operator for confirming that the acquired screen has sufficient characteristics to be considered a valid evidence that the device presented is in factory reset mode.

Embodiments that provide PoSE needs to acquire the POD IMEI. This may be useful for associating a factory reset device with a previous phase evaluation (Phase 1), and also useful to determine, using service interfaces for example REST API calls to service providers for additional information about the device, for example blacklist status, finance information, lock information, etc.

Some embodiments providing PoSE may begin by capturing a user identifier, such as a phone number associable with the user.

To acquire the IMEI as well as acquire one good evidence element that a device complies with PoSE requirements, some embodiments may provide user-based navigation instructions, for example using a kiosk, a PED or other companion device, guiding the user to bring the POD to a screen displaying the IMEI. For example, with Apple up to iOS 16, this is achieved by: Powering on the device; Touching the screen; Pressing the (i) button located on the lower right area of the screen; Presenting the device to a camera enabled computing device (such as, e.g., a kiosk or PED).

The info screen provides a critical information that is necessary for determining a complete POSE: the IMEI.

After the device has been presented to a camera operable by the system, the camera may detect the presence of a phone or recognize features, or be triggered by a user action in order to take a physical digital image or video of the POD containing the relevant information, in this case the IMEI.

For embodiments implementing a PoSE for Apple devices, the IMEI may then be used to perform a usage limitation lock such as user account lock, also known as FMIP (Find my iPhone) check for determining that the device is not in a locked state, which can serve as a second evidence for determining PoSE state of the device.

Usage limitation locks are mechanisms that prevent at least in part the usage including transfer of the device. As described, they include FMIP and similar locks, but also MDM locks which could prevent in part the use of some features of the device, or carrier locks including financing locks which may prevent easy transfer of the device, or any other lock implemented in order to restrict, prevent or limit the usage of the device which would of course limit the trade value of a POD.

On some mobile devices, namely Android based devices, the IMEI may not be made visible on the initial device information screens and therefore the evidences for PoSE determination must be collected otherwise.

In some embodiments of the present invention, a method based on enrolling a device using Mobile Device Management (MDM) can be used to collect or help collect evidence for determination of proof of secure erasure.

MDM are solutions offered by both Apple and Android for facilitating certain organization tasks with regards to fleets of devices they may own or otherwise control. As per Wikipedia (December 2022), “Mobile device management (MDM) is the administration of mobile devices, such as smartphones, tablet computers, and laptops. MDM is usually implemented with the use of a third-party product that has management features for particular vendors of mobile devices.”

On Android devices, in order to install a fully managed MDM application, an enrollment process is needed and it is a requirement that the device first be data erased. As such, the ability to install a fully managed MDM application can be collected as an evidence of secure erasure, however, insufficient by itself.

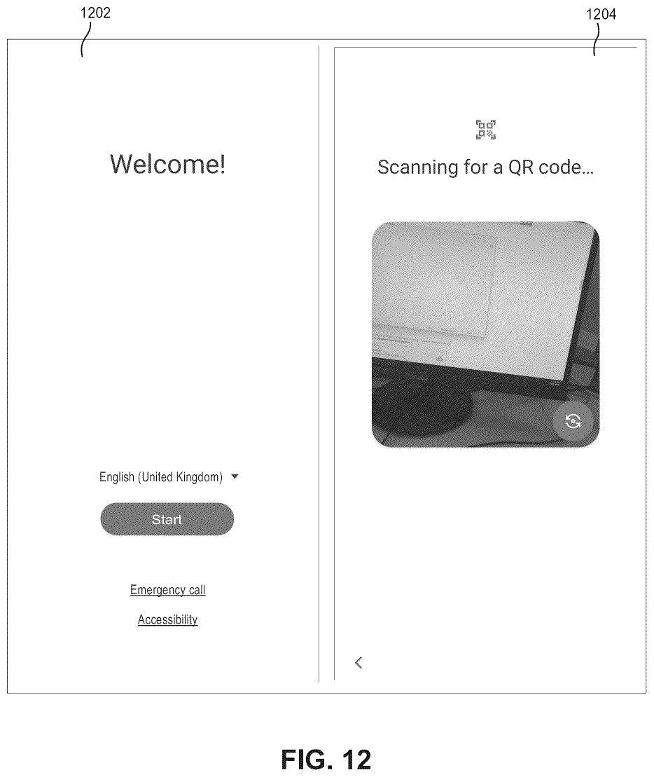

The installation process of fully managed MDM applications on Android devices begins by instructing the user to tap 6 times on the mobile device screen. This, in recent OS, causes the display of a special enrollment page (e.g., screens 1202 and 1204 shown in FIG. 12) which turns the camera into QR scanning mode.

Some embodiments of the invention are implemented by using special purpose MDM software which have the purpose to complement the system for determination of PoSE and capturing of other device or user information (herein SP MDM). SP MDM is a special purpose of a mobile executable software triggered, downloaded or otherwise made accessible to a mobile device using an OEM/OSP MDM platform or service interface, such as Google endpoint management (GEM) or the Apple MDM.

Embodiments using SP MDM are programmed in a specific way so to be able to provide at least one evidence of PoSE or contribute to such evidence, for example by determining the state of a specific device and/or reporting on a device unique identifier, and possibly other additional information.

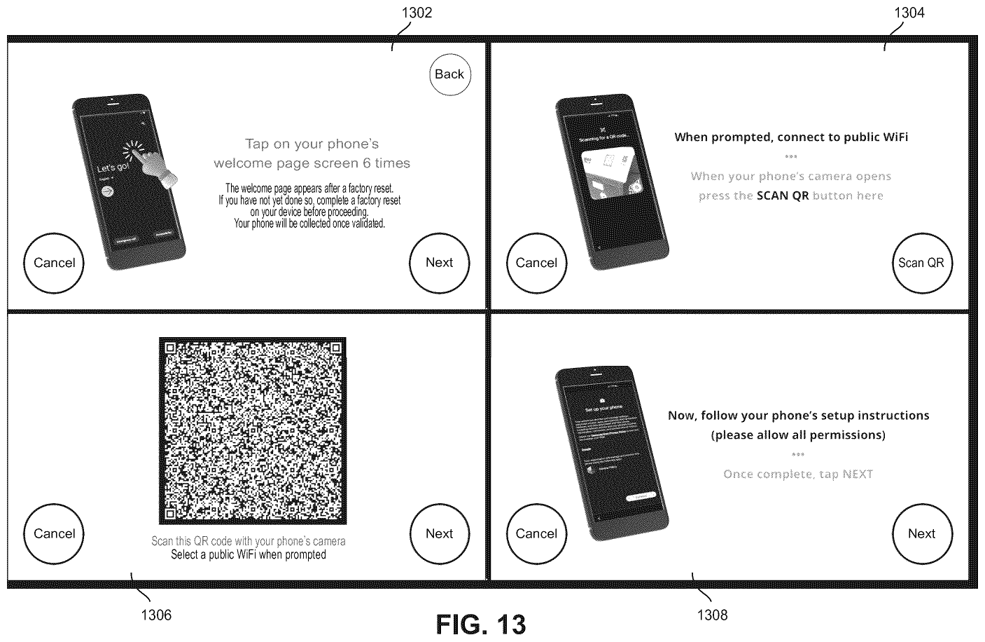

Embodiments using SP MDM may provide instructions to the user for installing the SP MDM, for example using a companion device and displaying a specially encoded QR code containing MDM enrollment information. FIG. 13 illustrates a progression 1302, 1304, 1306 and 1308 of such instructions.

For example, on an Android device the instructions may include navigating the user to perform the steps of tapping the screen 6 times, scanning using the mobile device of a SP MDM enrollment QR code and accepting the various conditions will cause the SP MDM to be downloaded, installed and executed on the mobile device.

Some embodiments of the invention making use of SP MDM are capable of retrieving a device IMEI number using special system calls available only to MDM mobile executable software which can be an evidence of PoSE status.

Furthermore, embodiments of the present invention making use of SP MDM may use various techniques for example pairing with a companion device using any common pairing mechanism including mechanisms described herein and in other of the applicant's applications, for example, display of a unique QR code on the mobile device which is scanned by a companion device, such as a kiosk or other mobile device, to pair an instance of the SP MDM with a transaction on the system.

A detailed example of an embodiment making use of SP MDM may proceed as follows:
A user wishes to have its mobile device inspected for example in order to obtain a trade-value at a system using a kiosk;
The system may be configured (optionally) to demand the user to run a diagnostic mobile executable software for performing some diagnosis on the device, in order to collect information, responses or results and associate such with the current transactional instances;
The system may provide data transfer navigation instructions either on a companion device, on the mobile device for example using the diagnostic mobile executable software or another mobile executable software, which helps the user performs necessary data backup steps;
The system may perform verifications for example likely using the IMEI identifier and using service interfaces to 3rd party database to obtain additional information, for example about the mobile device, an activated mobile service with a carrier, blacklist status, etc. and collect relevant responses associable with the transactional instance;
Using the collected information of the transactional instance, the system may provide a quote for trade-in of the device;
When using the optional steps above, the system associates relevant information with the transactional instance which will later enable the system to retrieve information, for example quoted price for a specific device;
Once the (optional) steps above have been performed, the system provides data erasure navigation instructions according to the specific OEM/OSP instructions applicable to the mobile device, either on a companion device, on the mobile device for example using the diagnostic mobile executable software or another mobile executable software;
The system may offer a period of time allowing the user to properly perform any data backup and to perform required data erasure process, for example the system may present the quote as “Valid for 48 hours”; and
Once users have terminated the indicated data erasure process, they may proceed to the PoSE phase which begins, in this kiosk-based embodiment example, by interacting with the kiosk (e.g., companion device).

In the above example process, the system may provide a method for accessing the diagnostic mobile executable software, for example using a URL to a web application, a mobile application or a “Fast-App”. The system may capture user information, for example a mobile telephone number, which can be captured by manual entry by the user, or by using navigation-based instructions as described herein. The diagnostic mobile executable software may perform some tests, including user assisted tests, automated tests and machine to machine tests (using the companion device). The system may provide user navigation instructions to guide the user for performing the necessary steps to display some desirable information such as the IMEI. Optionally, the diagnostic mobile executable software may use Picture in Picture feature to provide an on-screen display of instructions for navigating the user The diagnostic mobile executable software may ask for permission to access frame-buffer screen information (FIG. 9). The diagnostic mobile executable software may be used to perform frame-buffer based screen captures which may be use to capture images of desirable information. Alternatively, the companion device camera may be used to capture images of desirable information displayed on the mobile device. Optionally, the diagnostic mobile executable software may use captured images to tailor navigation instructions to the specific instance, for example, waiting the user to be in a certain menu before proceeding to the next instruction.

The companion device may provide different POSE instructions based on the make and model and/or operating system of the mobile device and may provide SP MDM which this example details below;

For embodiments and devices using SP MDM for POSE: The system may present navigation instructions for installing the SP MDM mobile executable software on the mobile device, for example, connecting to a WiFi which may be a captive portal offered by a companion device, how to activate the QR scanner, etc. (FIG. 12 and FIG. 13) so that the SP MDM is downloaded and executed on the mobile device; and during or after the SP MDM execution a sequence of several operations is performed.

The sequence of several operations performed during or after the SP MDM may include: The SP MDM retrieves information which typically includes at least unique identifier such as the IMEI, MAC address, etc.; Communicate with the system, typically to a system's server, at least the unique identifier which may be encrypted or hashed; The system creates or associates pairing information for example a unique QR code or PIN code to allow the pairing of a companion device transactional instance with the SP MDM instance; A pairing process is performed, for example the user may enter a PIN on a companion device or present a QR code to a companion device camera; or The system may in some instances be capable of automatically pairing devices when pairing information is automatically available to the companion device, for example when the MAC address is available when the system is using a captive portal, the MAC retrieved from the network hotspot provided by the companion device may be used to pair the device using the SP MDM digitally retrieved MAC address.

Embodiments of the present invention making use of SP MDM are capable of retrieving and accessing more information, features and system calls than typical mobile applications. As such, they can be used to collect additional evidence for determination of a PoSE, such as digitally retrieving the IMEI. Additionally, some MDM are capable of triggering a remote data erasure process.

Some embodiments may rely on a single evidence for determining that a device is in the recommended and safe OEM/OSP factory reset stage, however, there are several instances where only one evidence is not sufficient to obtain reasonable proof that a device is not only in a factory reset stage, but that it was brought to that stage using the recommended method for erasing data, and that it is not locked to a user or other account. It is important to note that having a device in a “reset” mode is generally not sufficient to ensure PoSE as there are various methods to bring a device in “reset mode” which may not be the “recommended and safe OEM/OSP factory reset” for device ownership transfer. As an example, some device recovery methods may initiate partial reset which may not erase the data, or may not remove usage limitation locks.

Some embodiments may also rely on user declaration that the proper steps have been performed, and while this may not provide for ascertained or high confidence PoSE, could still limit exposure or the involved parties in the transaction.

Embodiments implementing a PoSE for mobile devices may combine evidences before determining that the device has been securely erased and such determination may be adapted for example based on make, model or operating system and/or version.

As such, for example, on some Apple mobile devices a PoSE may be the combination of:
Obtaining an IMEI, using a camera of a companion device for taking an image from the display of the mobile device when the user has navigated to certain specific device information page, extracting the IMEI using character recognition techniques possibly with pattern matching and storing the image and extracted information as a possible first but insufficient evidence which associate a transactional instance to an IMEI;
Imaging device uniqueness information, such as defects and possibly micro-differences which may be sufficient evidences that two device taken at two distinct time is the one and same device, but as such not an evidence of POSE;
Ensuring, in a second phase, using a camera of a companion device, that the device is now displaying specific screens only accessible when a factory reset operation has been completed as a second but insufficient evidence;
Ensuring, using service interface to external database for example using REST API that there is no account information such as FMIP associated to the device at that time which is a third but insufficient evidence; and
Combining the multiple acquired evidences as a sufficient evidence that the device is, at that specific date and time, in a proper PoSE state, including no user account/user lock.

Likewise, on some Android devices, a PoSE may be the combination of:
Obtaining an IMEI, using a camera of a companion device for taking an image from the display of the mobile device when the user has navigated to certain specific device information page, extracting the IMEI using character recognition techniques possibly with pattern matching and storing the image and extracted information as a possible first but insufficient evidence which associate a transactional instance to an IMEI;
Providing instructions to the user for the MDM device enrollment using a SP MDM software which will cause the MDM server-side software component to become aware of the enrollment of a specific IMEI, which, is a second good evidence by itself, but do not provide the association with a transactional instance and/or a user; and
Combining the multiple acquired evidences as sufficient evidence that the device is in a proper PoSE state, associable with a user, and that no user or enterprise account other than the full MDM management.

In the above example, for example, the capture reset evidences process 1604 shown in FIG. 16 illustrates an example third phase that follows an example second phase 1602. At 1606, the user may be guided by mobile application software to transfer data from the POD (see FIG. 15) and to optionally reset the POD. Subsequently at operations 1608-1614 the user is guided by navigation instructions (displayed in PiP window on the POD or on a companion device) to display an evidence (e.g., the IMEI) that is captured from the framebuffer of the POD. Following the data erasure process 1602, in process 1604 the POD may display (or be caused to display) evidence such as a known screen (e.g., hello screen in FIG. 10) indicating that the POD has been reset (operation 1618) and a pairing (operation 1620) with a companion device and optionally the user is performed. The pairing enables further evidence to be acquired for the POSE. In the illustrated embodiment, the pairing is based on a QR code displayed on the POD and captured by the companion device. In some embodiments the pairing may be based on another technique, such as that shown in FIG. 15.

The example above is generic in nature and evidences may be the combination, in accordance with predetermined rules of combination, of a plurality of elements which may vary depending on the level of certainty needed for specific use-cases, partnerships or other. As such, possible evidences may be:
Physical images of a mobile device;
Digital screen capture of a frame buffer of a mobile device;
Unique identifiers, extracted possibly from images including physical images or screen captures using frame buffer, such as IMEI, MAC, Bluetooth, serial number;
User information, such as name, email phone number, which may have been extracted possibly from images, including screen captures using frame buffer, user entered, or validated through for example 2-way validation, such information adding user traceability to the transactional instance when desirable;
Specific system calls for retrieving device or user specific information performed by a controlled mobile executable software which communicate retrieved information to a server; and
Database or 3rd party query responses for example using service interfaces to REST API.

As such, embodiments of the present invention can implement proof of secure erasure (PoSE) as the result of combining evidence collected from a plurality of data points.

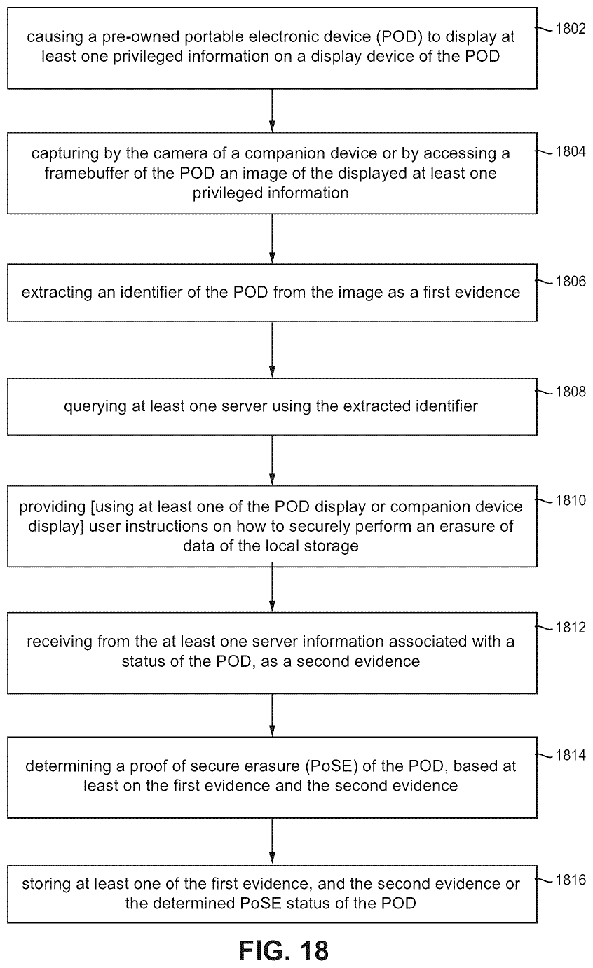

FIG. 18 illustrates a flowchart for a process 1800 for providing PoSE for a POD, according to some embodiments. Process 1800 may be performed in a system comprising the POD comprising at least one first processor and a local storage, a companion device comprising at least one second processor, a display device and a camera, and configured to communicate with at least one server comprising at least one third processor. Operations 1802-1816 may be performed on one or more processors of the system.

At 1802, the POD is caused to display at least one privileged information on a display device of the POD.

At 1804, an image of the displayed at least one privileged information is capturing by the camera of a companion device or by accessing a framebuffer of the POD. In some embodiments, the image is a video image. The companion device may be one of a kiosk, a portable investigation device (PED), a tablet, a desktop computer, or an embedded computing device.

At 1806, an identifier of the POD is extracted from the image as a first evidence.

At 1808, at least one server is queried using the extracted identifier.

At 1810, using at least one of the POD display or companion device display, user instructions on how to securely perform an erasure of data of the local storage are provided.

At 1812, information associated with a status of the POD is received from the at least one server, as a second evidence.

At 1814, a PoSE of the POD is determined based at least on the first evidence and the second evidence. The determining of the POSE may comprise determining the PoSE only if the POD is determined to be data erased and free from usage limitation lock. Alternatively, determining of the PoSE may comprise determining the PoSE only if the POD is determined to be data erased. Determining the PoSE may require a high level of reliability of multiple evidences.

Determining the PoSE may comprise combining at least the first evidence and the second evidence according to one or more predetermined rules. The first evidence and the second evidence may be collected according to manufacturer recommendations by collecting a plurality of evidence information.

At 1816, at least the first evidence and the second evidence are stored in association with each other.

Process 1800 may further include display the POSE indicating that the POD was, at a specific moment, free from sensitive user information.

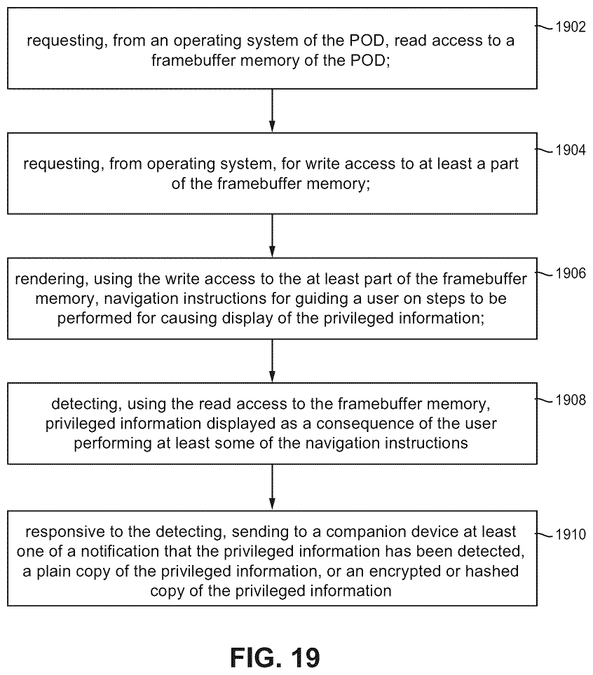

FIG. 19 illustrates a flowchart for a process 1900 for providing privileged information optionally in association with PoSE, according to some embodiments. Process 1900 may be performed in a system comprising the POD comprising at least one first processor and a local storage, a companion device comprising at least one second processor, a display device and a camera, and configured to communicate with at least one server comprising at least one third processor. Operations 1902-1910 may be performed on one or more processors of the system.

At 1902, read access to a framebuffer memory of the POD is requested from the operating system of the POD. The requesting read access to the framebuffer memory of the POD may cause the operating system of the POD to request a user input to grant the read access and provide access or methods to read, directly or indirectly, the framebuffer memory.

At 1904, write access to at least a part of the framebuffer memory is requested from the operating system. The requesting write access to the framebuffer memory of the POD may cause the operating system of the POD to request a user input to grant the write access and provide access or methods to write, directly or indirectly, the framebuffer memory.

At 1906, using the write access to the at least part of the framebuffer memory, navigation instructions for guiding a user on steps to be performed for causing display of the privileged information are rendered. the rendering may be performed to a picture-in-picture (PiP) window on a display of the POD.

At 1910, using the read access to the framebuffer memory, privileged information displayed as a consequence of the user performing at least some of the navigation instructions is/are detected.

At 1912, responsive to the detecting at 1910, at least one of a notification that the privileged information has been detected, a plain copy of the privileged information, or an encrypted or hashed copy of the privileged information, are sent to a companion device.

In some embodiments associated with process 1800 and/or 1900, at least one of a manufacturer of the POD or the operating system of the POD is detected, and, responsive to the detection, an instruction set is selected or adapted from at least two instruction sets. Then, from the instruction set, multimedia, audio, text and/or video instructions are provided indicating steps to be performed by a user for navigating to one or more screens that contain a relevant information. The relevant information may include at least one of an IMEI, MAC address, serial number, model number, battery health information, or storage capacity.

Then, either by using a camera or by using a direct or indirect access to a framebuffer memory of the POD, the image containing the relevant information displayed on the POD as a consequence of execution of the instruction set by the user is captured, and the relevant information is extracted from the image. The extracted relevant information is then stored in a transaction data structure. The transaction data structure may be used as, at least a part of, POSE.

Some aspects of the present disclosure are summarized below.

In one example system for determining a proof of secure erasure of a first device, the first device is a uniquely identifiable mobile device on which data erasure status, and optionally, usage limitation lock validation, needs to be determined. The example system also comprises a second device which may be a kiosk, a mobile device, a tablet, a desktop or embedded computing device. The second device comprises at least one computing element, a display, a camera and the second device is operably in communication with at least one server. The system is further configured to perform the steps of: providing user instructions for guiding a user to navigate the first device to at least one system information screen which will cause the display of at least one privileged information, or for example, of the IMEI; capturing, using the camera of the second device or accessing directly or indirectly information contained on the frame buffer of the first device, at least an image or video of the displayed privileged information on the first device; extracting an identifier of the first device from the at least one image or video of at least one first evidence; querying at least one server using the extracted identifier associated with the first device; and receiving from the queried server information about the status of the first device as at least a second evidence; determining or inferring a proof of secure erasure, based on said at least two evidences only if the first device is reputed to be data erased and free from usage limitation lock; and storing evidence information.

Another system for determining a proof of secure erasure of a first device, the first device is a uniquely identifiable mobile device on which data erasure status, and optionally, usage limitation lock validation, needs to be determined. The system also comprises a second device which may be a kiosk, a mobile device, a tablet, a desktop or embedded computing device, and the second device comprises at least one computing element, a display, a camera and said second device being operably in communication with at least one server. The system further comprising the steps of: determining the first device operating system; selecting an evidence logic; and selecting or adapting, based at least on the first device operating system, the user experience flow for interacting with the system wherein the user experience flow will collect at least one evidence.

Another system/method for electronic device assessment is provided where the electronic device assessment includes the electronic capturing of information that requires specific user navigation steps. The system is arranged as a plurality of software components and further comprises of: a device assessment data container containing information about said device or about a transactional instance associable with said device; a capability to transfer to the electronic device at least one software component containing a mobile executable software; a capability to execute the software component on the electronic device; at least one user navigation instruction rendering software component for communicating to the user the required user navigation steps that needs to be performed, wherein the media rendered can be audio, images and/or video and may be rendered using at least one of the electronic device display, the electronic device audio rendering subsystem, a companion device display and/or a companion device audio rendering subsystem; at least one screen imaging process which may be a physical imaging of the electronic device using a software component on a companion device and a camera, or a direct frame-buffer access to the in-memory graphical information of the display of said electronic device, wherein the imaging method capture, using an image displayed that is the result of the user performing the navigation instructions; a software component operably in communication with an imaging method capable of recognizing or extracting information from the at least one image that is the result of the user performing the navigation instructions, optionally using programmatic or artificial intelligence inference methods or both; and storing or associating said information in or with the data container.

In the immediately preceding paragraph, the navigation-based information may be IMEI. In the immediately preceding paragraph, the navigation instructions have been rendered by the mobile executable software using overlaid picture in picture functionality.

Another example system provides for accessing relevant information, where the relevant information includes at least one of a POD IMEI, MAC address, Serial number, Model number, Storage Capacity, etc. The system comprises: at least one software component executed on a computing device operable by the system which is able to detect at least one of the manufacturer of the portable device or the operating system of the portable electronic device, and select or adapt an instruction set from at least two instruction set; at least one software component executing after the instruction set has been selected, on any computing device operable by the system for providing multimedia, audio, text and/or video instructions indicating the steps required to be performed by a user for navigating to the specific screens that contain the relevant information; at least one software component capable to capture an image, either by using a physical camera or by using a direct or indirect access to the portable device framebuffer memory, the image containing the relevant information displayed on the portable device as a consequence of the execution of the instruction set by the user; at least one software component executed on a computing device operable by the system for extracting using at least one image captured the relevant information and storing the relevant information in a data container associable with other data related to the portable electronic device.

Another example computing arrangement for acquiring privileged information on a mobile device, comprises the steps of: executing on a mobile device a mobile executable software; requesting, by the mobile executable software, a direct or indirect read access to the mobile device framebuffer memory which causes the operating system to ask the user to grant said read access and provide access or methods for the mobile executable software to read, directly or indirectly, the framebuffer memory; requesting, by the mobile executable software, a direct or indirect write access to a part of the framebuffer memory window (Picture in Picture) to the operating system which causes the operating system to provide direct or indirect access or functions to write information to at least a subset of the framebuffer memory; rendering, by the mobile executable software and using the write access to part of the framebuffer memory, navigation instructions for guiding the user on steps to be performed for causing the display of the privileged information; recognizing, by the mobile executable software and using the read access to the framebuffer memory, privileged information displayed as a consequence of the user performing the navigation instructions; and, after recognition by the mobile executable software of the privileged information, sending to another computing element at least one of 1) a notification that the privileged information has been recognized, 2) a plain copy of privileged information 3) an encrypted or hashed copy of the privileged information.

In example embodiments, the PED may be a smartphone, tablet, or the like, and has an installed mobile application for performing an evaluation of the POD or part thereof. The mobile application and/or a diagnostic/evaluation application may be stored in a non-transitory memory of the PED, POD and/or may be obtained from a website, such as, for example, a website associated with a central server and/or kiosk providing evaluation services, or an application store such as Apple Store™ or Google Play™. The PED may connect via a communication connection to a network which connects to the central server and/or a kiosk. The PED may establish a communication connection, and in some cases may be paired with, the POD. The POD may be installed with a diagnostic app and/or mobile application via the PED or by another means. The PED is not attached to a fixed infrastructure (e.g., such as a kiosk or booth) when performing evaluation of or communicating with the POD.

Although particular embodiments have been described above, a person of skill in the art having been provided with this disclosure, would appreciate aspects of the different embodiments may be used in various combinations to realize still other embodiments of an electronic kiosk for recycling electronic devices.

While the embodiments presented herein have been described in detail, the foregoing description is in all aspects illustrative and not restrictive. It is understood that numerous other modifications and variations can be devised without departing from the scope of the disclosed embodiments.

What is claimed is:

1. A system for determining a proof of secure erasure (PoSE) of a pre-owned portable electronic device (POD), comprising:
the POD comprising at least one first processor and a local storage;
a companion device comprising at least one second processor, a display device and a camera, and configured to communicate with at least one server comprising at least one third processor,
wherein one or more processors of the system are configured to perform operations comprising:
causing the POD to display at least one privileged information on a display device of the POD;
capturing by the camera of the companion device or by accessing a framebuffer of the POD an image of the displayed at least one privileged information;
extracting an identifier of the POD from the image as a first evidence;
querying at least one server using the extracted identifier;
providing user instructions on how to securely perform an erasure of data of the local storage;
receiving from the at least one server information associated with a status of the POD, as a second evidence;
determining the PoSE of the POD, based at least on the first evidence and the second evidence; and
storing at least one of the first evidence, the second evidence or a status of the determined POSE.

2. The system according to claim 1, wherein the determining the POSE comprises determining the PoSE only if the POD is determined to be data erased.

3. The system according to claim 1, wherein the determining the POSE comprises determining the PoSE only if the POD is determined to be data erased and free from usage limitation lock.

4. The system according to claim 1, wherein the capturing by the camera of the companion device or by accessing a framebuffer of the POD an image of the displayed at least one privileged information comprises capturing the displayed at least one privileged information by the camera.

5. The system according to claim 1, wherein the capturing by the camera of the companion device or by accessing a framebuffer of the POD an image of the displayed at least one privileged information comprises capturing the displayed at least one privileged information by accessing the framebuffer.

6. The system according to claim 1, wherein the image comprises a video image.

7. The system according to claim 1, wherein the companion device is one of a kiosk, a portable investigation device (PED), a tablet, a desktop computer, or an embedded computing device.

8. The system according to claim 1, wherein the at least one privileged information is an International Mobile Equipment Identity (IMEI).

9. The system according to claim 1, wherein the determining the POSE of the POD, based at least on the first evidence and the second evidence, comprises combining at least the first evidence and the second evidence according to one or more predetermined rules.

10. The system according to claim 9, wherein the first evidence and the second evidence are collected according to manufacturer recommendations by collecting a plurality of evidence information.

11. The system according to claim 1, wherein the one or more processors are further configured to display the PoSE indicating that the POD was, at a specific moment, free from sensitive user information.

12. A method for determining a proof of secure erasure (PoSE) of a pre-owned portable electronic device (POD), comprising:
causing a pre-owned portable electronic device (POD) to display at least one privileged information on a display device of the POD;
capturing by the camera of a companion device or by accessing a framebuffer of the POD an image of the displayed at least one privileged information;
extracting an identifier of the POD from the image as a first evidence;
querying at least one server using the extracted identifier;
providing user instructions on how to securely perform an erasure of data of the local storage;
receiving from the at least one server information associated with a status of the POD, as a second evidence;
determining a proof of secure erasure (PoSE) of the POD, based at least on the first evidence and the second evidence; and
storing at least the first evidence and the second evidence.

13. The method according to claim 12, wherein the providing user instructions on how to securely perform an erasure of data of the local storage comprises providing, using at least one of the POD display or companion device display, user instructions on how to securely perform an erasure of data of the local storage.

14. A method executed on a pre-owned portable electronic device (POD), comprising:
requesting, from an operating system of the POD, read access to a framebuffer memory of the POD;
requesting, from the operating system, for write access to at least a part of the framebuffer memory;
rendering, using the write access to the at least part of the framebuffer memory, navigation instructions for guiding a user on steps to be performed for causing display of the privileged information;
detecting, using the read access to the framebuffer memory, privileged information displayed as a consequence of the user performing at least some of the navigation instructions; and
responsive to the detecting, sending to a companion device at least one of a notification that the privileged information has been detected, a plain copy of the privileged information, or an encrypted or hashed copy of the privileged information.

15. The method according to claim 14, wherein the requesting read access to a framebuffer memory of the POD causes the operating system of the POD to request a user input to grant said read access and provide access or methods to read, directly or indirectly, the framebuffer memory.

16. The method according to claim 14, wherein the requesting write access to at least a part of the framebuffer memory causes the operating system to provide direct or indirect access or functions to write information to the at least part of the framebuffer memory.

17. The method according to claim 14, wherein the rendering is performed to a picture-in-picture (PiP) window on a display of the POD.

18. A system comprising one or more processors and one or more memory devices, wherein the one or more processors are configured to:
detect at least one of a manufacturer of a pre-owned portable electronic device (POD) or an operating system of the POD and, responsive to the detecting, select or adapt an instruction set from at least two instruction sets;
provide, from the instruction set, multimedia, audio, text and/or video instructions indicating steps to be performed by a user for navigating to one or more screens that contain a relevant information, wherein the relevant information includes at least one of an International Mobile Equipment Identity (IMEI), MAC address, serial number, model number, battery health information, or storage capacity;
capture at least one image, either by using a camera or by using a direct or indirect access to a framebuffer memory of the POD, the image containing the relevant information displayed on the POD as a consequence of execution of the instruction set by the user;
extracting, using the at least one image, the relevant information; and
storing the extracted relevant information in a data container in the one or more memory devices.

19. The system according to claim 18, wherein the data container is associable with other data related to the portable electronic device.
